(19) United States
(12) Patent Application Publication
(10) Pub. No.: US 2025/0175900 A1
(43) Pub. Date: May 29, 2025

(54) METHOD AND SYSTEM FOR ENERGY MANAGEMENT BASED ON BATTERY LEVEL REPORTING FOR A-IOT

(71) Applicant: MEDIA TEK INC., Hsinchu (TW)

(72) Inventors: Chien-Chun CHENG, Hsinchu (TW); Chiao-Yao Chuang, Hsinchu (TW); Wei-De Wu, Hsinchu (TW); CHIOU-WEI TSAI, Hsinchu (TW); Tai-Cheng Tsai, Hsinchu (TW)

(21) Appl. No.: 18/954,631

(22) Filed: Nov. 21, 2024

Related U.S. Application Data
(60) Provisional application No. 63/602,689, filed on Nov. 27, 2023.

(51) Int. Cl. H04W 52/02; H04L 67/12; H04W 12/08

(52) U.S. Cl. CPC H04W 52/0235; H04L 67/12; H04W 12/08

(57) ABSTRACT

In an aspect of the disclosure, a method, a computer-readable medium, and an apparatus are provided. The apparatus may be a reader device. The reader device transmits, to an ambient Internet of Things (A-IoT) device, a downlink (DL) signal and validation information. The reader device receives, from the A-IoT device, a unique electronic product code (EPC) after the A-IoT device has validated the validation information. The reader device transmits, to the A-IoT device, a confirmation message in response to successful reception of the EPC from the A-IoT device.

### CROSS-REFERENCE TO RELATED APPLICATION(S)

This application claims the benefits of U.S. Provisional Application Ser. No. 63/602,689, entitled “Method and System for Energy Management Based on Battery Level Reporting for A-IoT” and filed on Nov. 27, 2023, which is expressly incorporated by reference herein in its entirety.

### BACKGROUND

### Field

The present disclosure is generally related to mobile communications and, more particularly, to methods and systems for improving the communication range, power consumption, and charging time for Ambient Internet of Things (A-IoT) devices with respect to user equipment (UE) and network apparatus in mobile communications.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a reader device. The reader device transmits, to an ambient Internet of Things (A-IoT) device, a downlink (DL) signal and validation information. The reader device receives, from the A-IoT device, a unique electronic product code (EPC) after the A-IoT device has validated the validation information. The reader device transmits, to the A-IoT device, a confirmation message in response to successful reception of the EPC from the A-IoT device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7(A) is a diagram illustrating an example wireless communication system including a base station and a UE.

FIG. 7(B) is a diagram illustrating an example communication link between a gNB and an A-IoT device though a connection with a UE via a wired cable.

FIG. 7(C) is a diagram illustrating an example communication link between a gNB and an A-IoT device though a connection with a UE via a wireless air interface.

FIG. 7(D) is a diagram illustrating a first type of an A-IoT device.

FIG. 7(E) is a diagram illustrating a second type of an A-IoT device.

FIG. 7(F) is a diagram illustrating a third type of an A-IoT device.

FIG. 7(G) is a diagram illustrating an example communication link between a UE and an A-IoT device via an air interface.

FIG. 7(H) is a diagram illustrating an example communication process between a UE reader/gNB and an A-IoT device based on a chosen time duration.

FIG. 7(I) is a sequence diagram that describes a modified 4-step RACH procedure.

FIG. 7(J) is a sequence diagram that describes a modified 2-step RACH procedure.

FIG. 7(K) is a sequence diagram that describes a modified RACH procedure where a UE acts as a tag reader.

FIG. 7(L) is a sequence diagram that describes a modified Sidelink procedure.

FIG. 8(A) is a diagram illustrating an issue of uncertainty on battery level.

FIG. 8(B) is a sequence diagram that describes a modified 4-step RACH procedure regarding power level indication.

FIG. 8(C) is a sequence diagram that describes a modified 2-step RACH procedure regarding power level indication.

FIG. 8(D) is a sequence diagram that describes a modified RACH procedure regarding low power mode.

FIG. 8(E) is a sequence diagram that describes a modified RACH procedure regarding a controllable reflection amplifier.

FIG. 9(A) is a diagram that describes introduction of a dedicated RF source that focuses on charging the A-IoT devices.

FIG. 9(B) is a sequence diagram that describes a modified RACH procedure regarding a dedicated RF charging source.

FIG. 10(A) is a diagram that describes implementation of a cooperative device discovery protocol where A-IoT devices help the gNB or UE discover other A-IoT devices.

FIG. 10(B) is a sequence diagram that illustrates the behavior of the UE, the gNB, and the A-IoT devices, and the signaling between them in the context of a cooperative device discovery protocol for A-IoT devices.

FIG. 11(A) is a sequence diagram that illustrates the behavior of the A-IoT device, the gNB, the RF charging source, and the signaling between them in the context of a coordinated charging and communication protocol for A-IoT devices.

FIG. 11(B) is a sequence diagram that illustrates the behavior of the A-IoT device, the gNB, the RF charging source, and the signaling between them in the context of a charging protocol based on communication needs for A-IoT devices.

FIG. 12(A) is a sequence diagram for a power-aware modulation protocol.

FIG. 12(B) is a sequence diagram for a passive wake-up mechanism.

FIG. 13(A) is a sequence diagram for a prioritized backscattering mechanism.

FIG. 13(B) is a sequence diagram for a battery level reporting mechanism.

FIG. 14(A) is a sequence diagram for a charging indication mechanism.

FIG. 14(B) is a sequence diagram for a adaptive antenna beamforming mechanism.

FIG. 15(A) is a sequence diagram for a solar energy harvesting mechanism.

FIG. 15(B) is a diagram that describes implementation of a system to control the intensity of the indoor light based on the power needs of the A-IoT devices.

FIG. 15(C) is a sequence diagram for an adaptive indoor lighting control mechanism.

FIG. 16 is a sequence diagram for a lighting-based power management mechanism.

FIG. 17 illustrates an example communication system having an example communication apparatus and an example network apparatus.

FIG. 18(A) is a flow chart of a process for handling uncertainty on battery level regarding a reader device and an A-IoT device.

FIG. 18(B) is a flow chart of another process for handling uncertainty on battery level regarding a reader device and an A-IoT device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

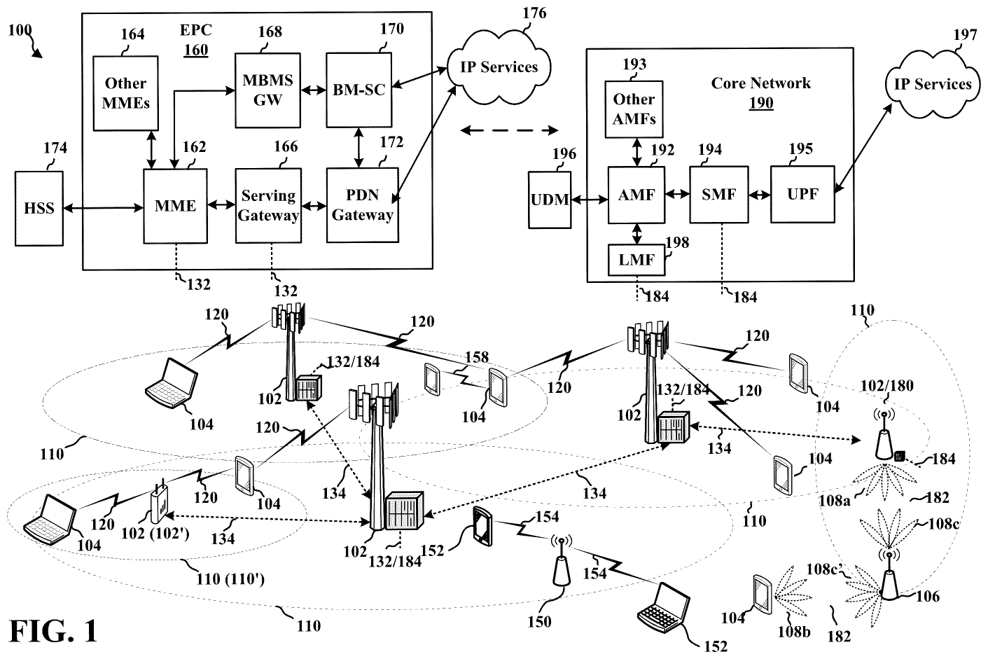

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR. The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

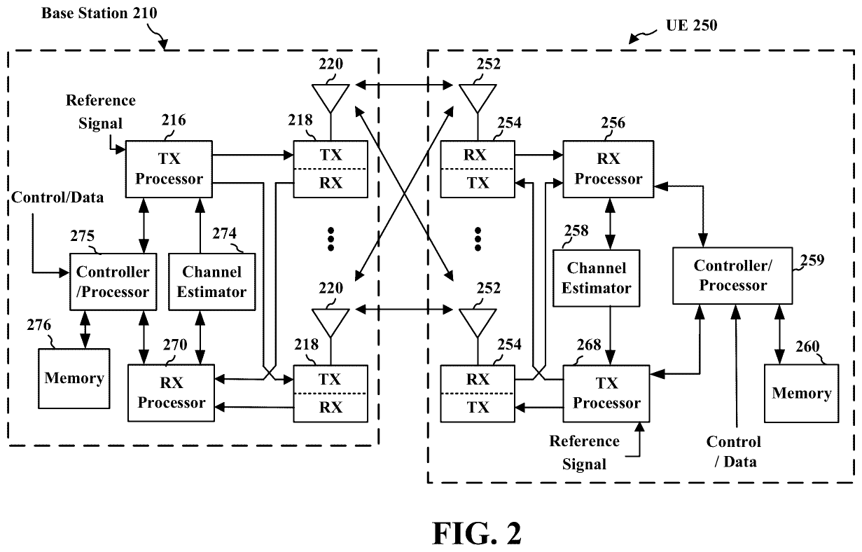

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

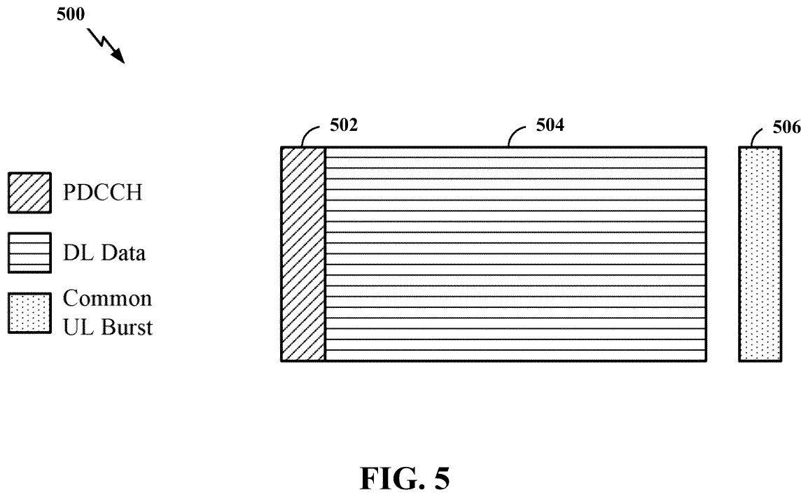

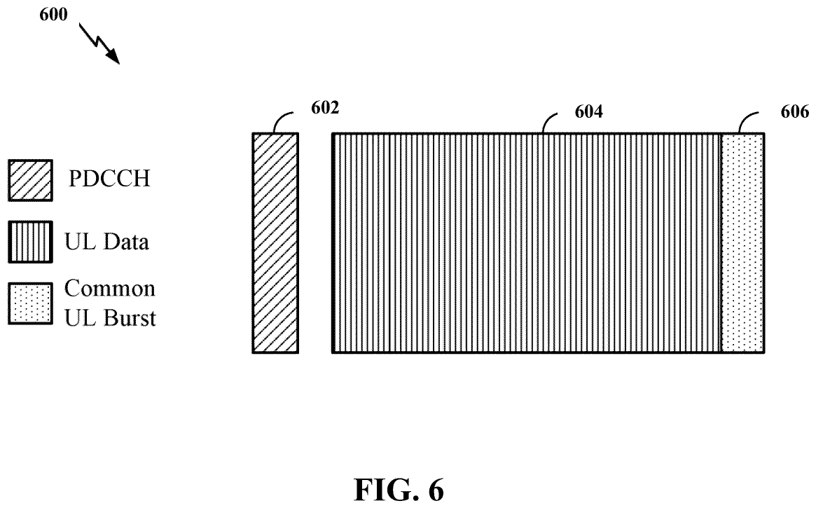

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

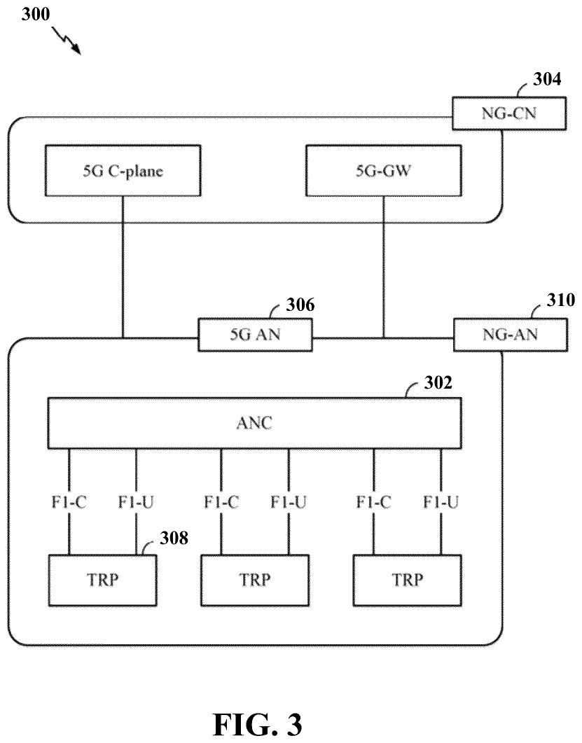

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

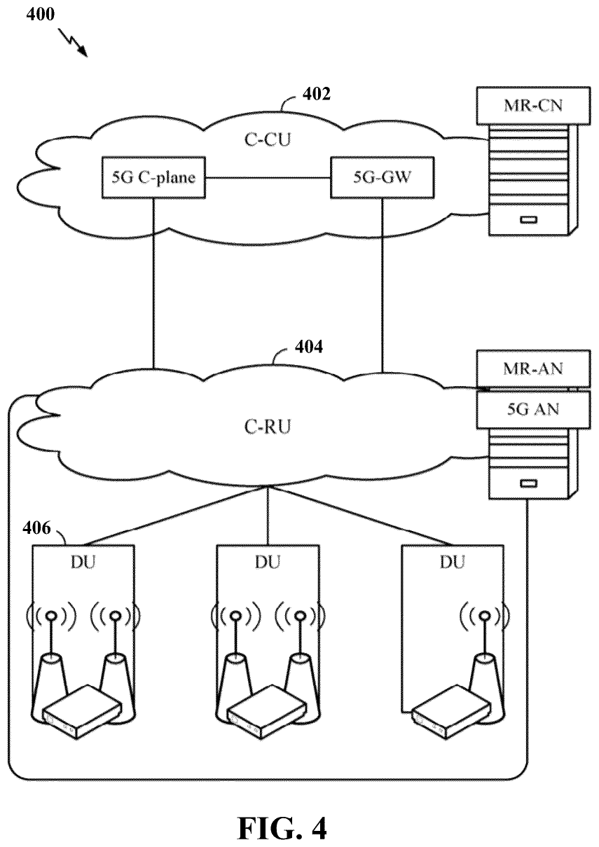

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

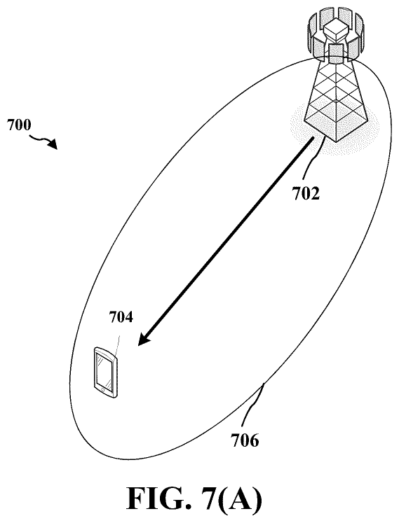

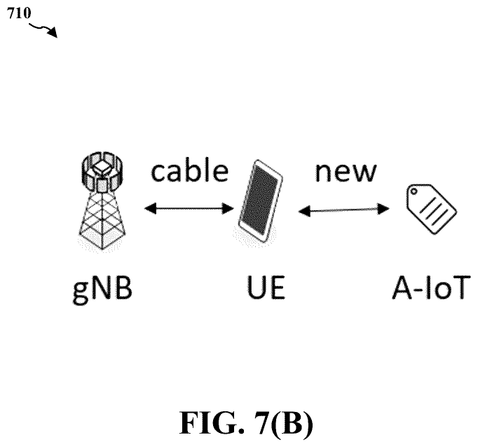

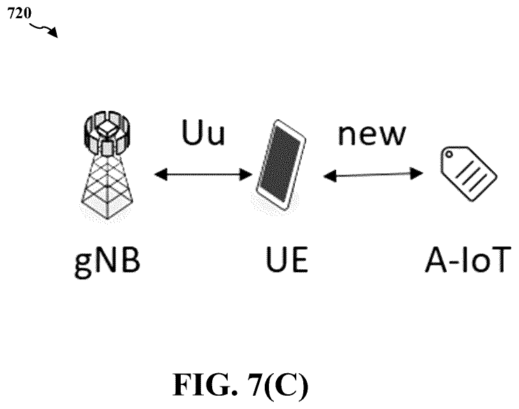

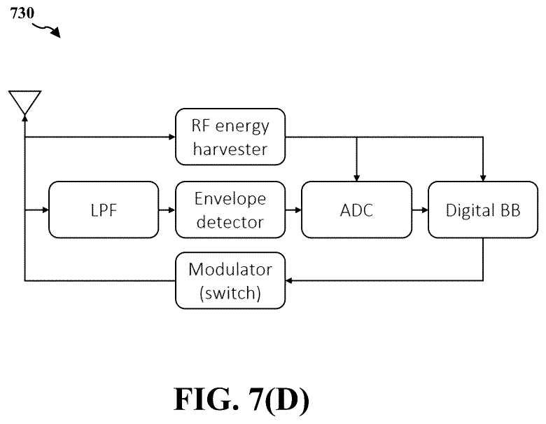

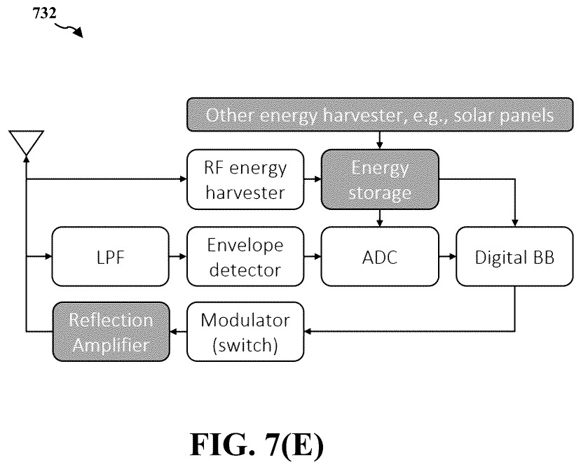

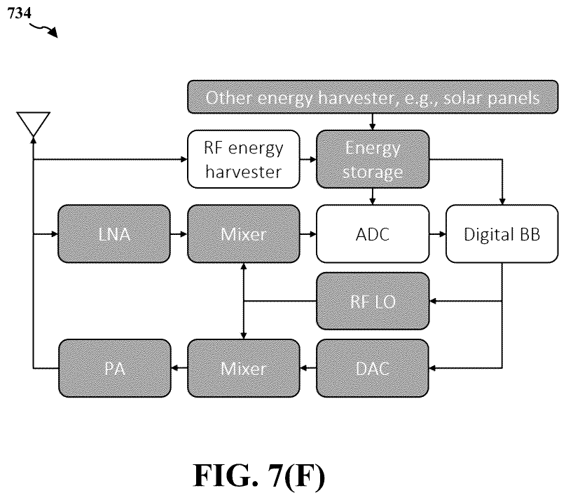

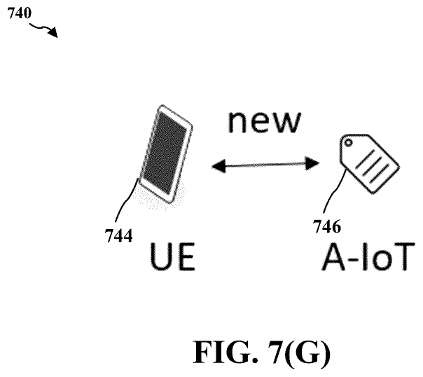

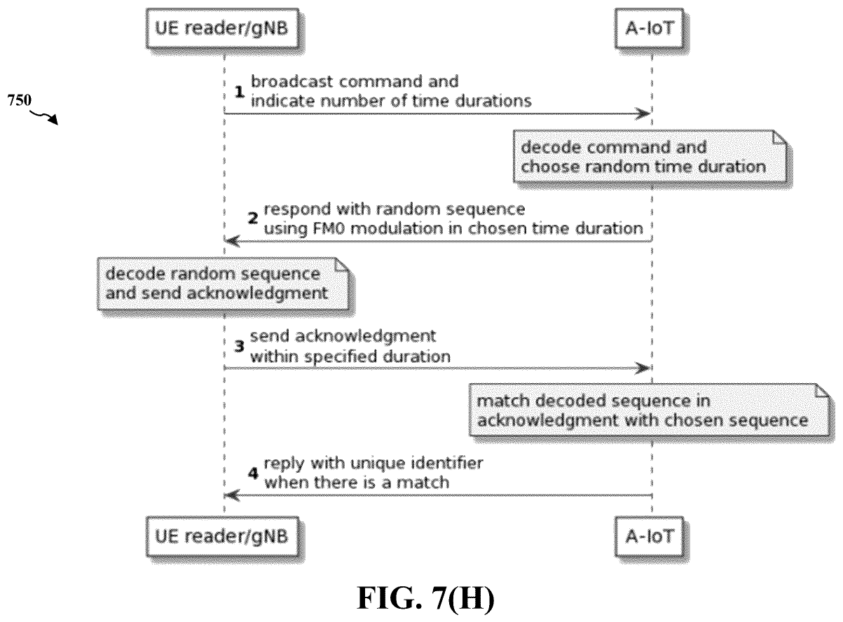

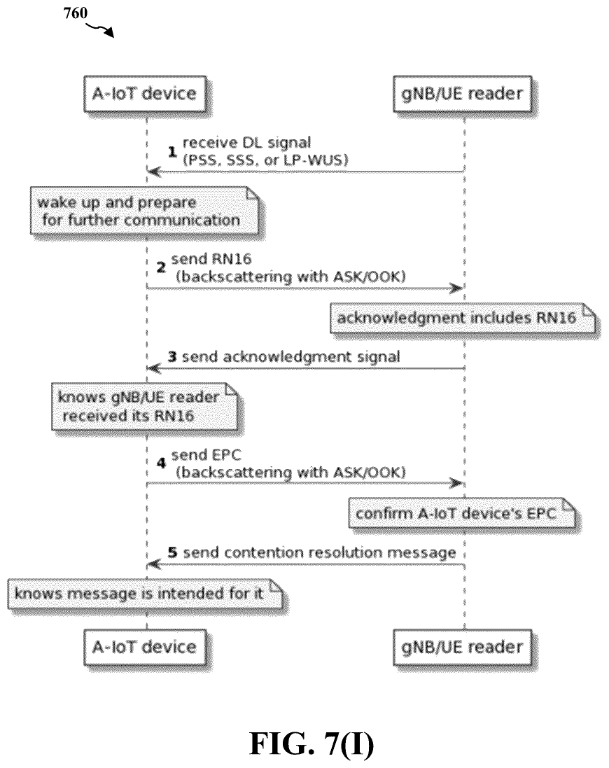

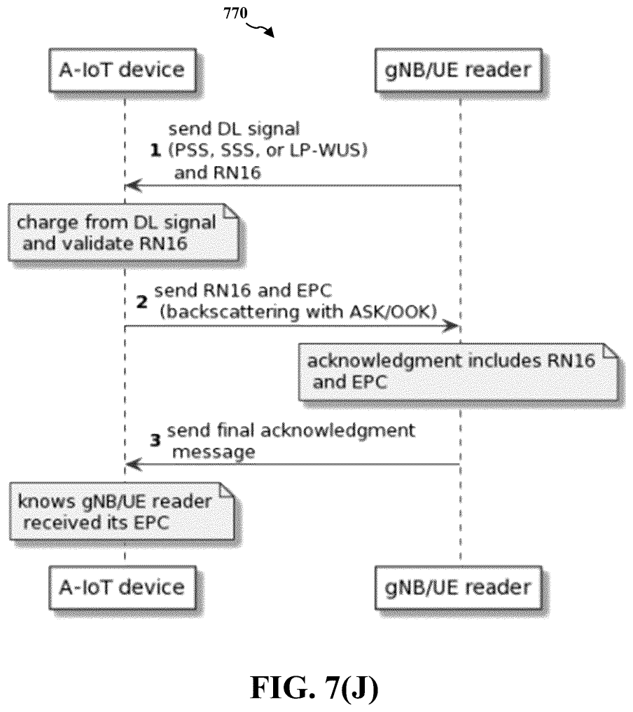

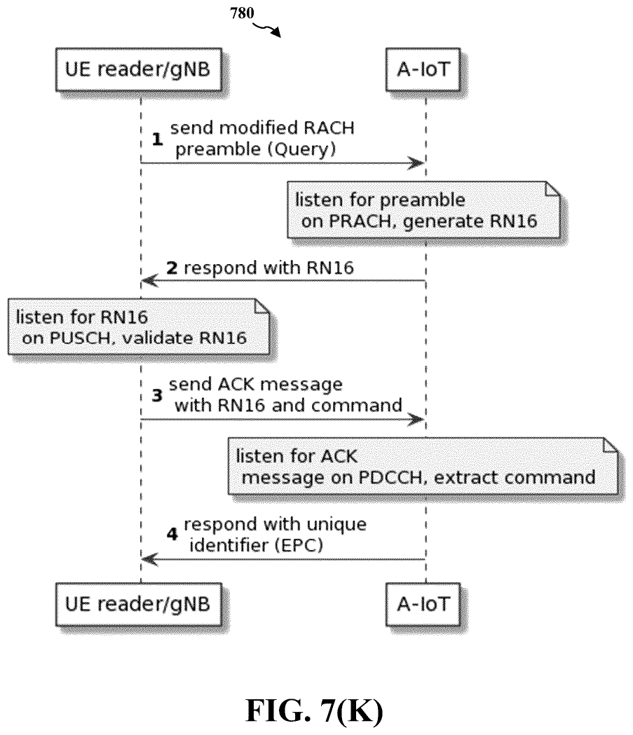

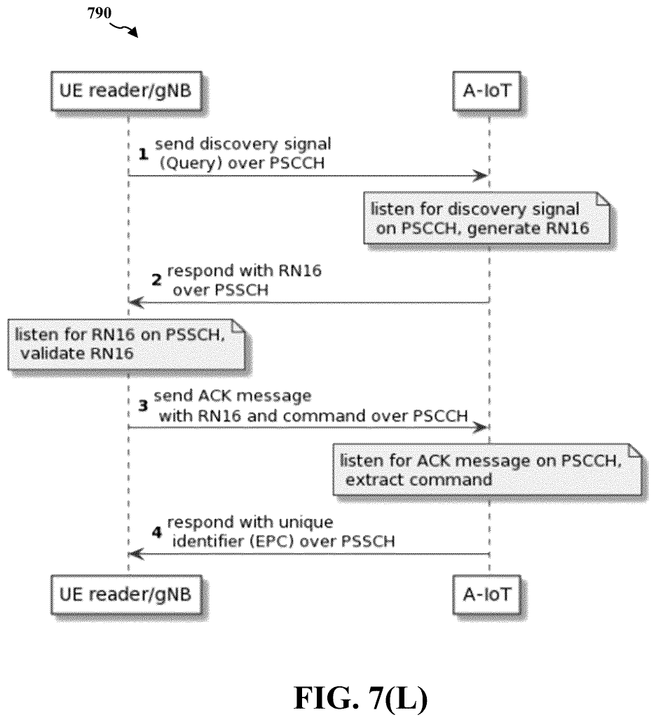

FIG. 7(A) is a diagram 700 illustrating an example wireless communication system including a base station and a UE. In this example, a UE 704 is connected to a base station 702 on a cell 706.

A-IoT devices often have limitations in terms of communication range, power consumption, and charging time. For instance, certain devices have a maximum coverage that is less than the maximum distance requirements for indoor use cases due to the activation power threshold. Increasing the transmit power can achieve the required range but may interfere with nearby base stations. Furthermore, the activation threshold of some devices depends on the rectifier's activation threshold in the RF energy harvester, leading to uncertainty for the base station to discover the device in a cell, especially when the device has low battery level or no battery.

The increasing use of IoT devices brings challenges in power management, with manual battery replacement or recharging being impractical due to cost, environmental, and safety factors. Existing technologies like barcodes and RFID also face limitations in reading range and interference. Therefore, there is a need for new IoT technologies that can support batteryless devices or those with energy storage that don't require manual intervention. The aim is to create a solution within 3GPP systems that can handle a high number of connections and device density, while reducing complexity and power consumption, thereby opening new markets and adding value across the value chain.

The present disclosure provides methods and systems for improving the communication range, power consumption, and charging time for A-IoT devices. The disclosure includes techniques for increasing the transmit power to achieve the required range while minimizing interference with nearby base stations. The disclosure also includes techniques for optimizing the activation threshold of devices based on the rectifier's activation threshold in the RF energy harvester, thereby reducing uncertainty for the base station to discover the device in a cell. Furthermore, the disclosure includes techniques for reducing the charging time for devices, particularly when using RF energy.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### System Topology

FIG. 7(B) is a diagram 710 illustrating an example communication link between a gNB and an A-IoT device though a connection with a UE via a wired cable. The present disclosure introduces a novel system topology for Ambient Internet of Things (A-IoT) communication. As shown in FIG. 7(B), the next-generation NodeB (gNB) establishes a connection with User Equipment (UE) or a UE reader via a wired cable. This configuration eliminates the need for a new air interface between the gNB and the A-IoT device, instead introducing a new air interface between the UE reader and the A-IoT device. As a result, the efforts required for any gNB specification change are significantly reduced. In this setup, the gNB can access the A-IoT device via the UE reader, which acts as an intermediate node between the device and the base station (gNB).

FIG. 7(C) is a diagram 720 illustrating an example communication link between a gNB and an A-IoT device though a connection with a UE via a wireless air interface. As shown in FIG. 7(C), a wireless air interface is established between the gNB and a UE or a UE reader. This air interface leverages the NR-Uu interface to minimize the specification change on the UE side. A new air interface between the UE and the A-IoT device is necessitated, the specifications of which can be determined based on the use cases and their corresponding requirements.

### Receiver Architectures

FIG. 7(D) is a diagram 730 illustrating a first type of an A-IoT device. Device A is designed with specific targets for power consumption during transmission/reception (≤1 μW or ≤10 μW), and complexity, which is aimed to be comparable to UHF RFID ISO18000-6C (EPC C1G2). Device A does not have energy storage or independent signal generation/amplification capabilities, and relies on backscattering transmission. It requires a backscattering activation power threshold, experiences reflection loss, and needs a distant carrier wave source to transmit signals for positioning.

The Architecture of Device A Includes the Following Components

A low pass filter (LPF) for suppressing adjacent sub-carrier interference (ASCI) and adjacent carrier interference (ACI);

An envelope detector (ED) to support On-Off Keying (OOK)-based signals;

An analog to digital converter (ADC) for digital baseband processing;

A digital baseband (DBB) for sequence matching;

A modulator (switch) controlled by the incoming signal to add payload data for OOK modulation; and

A radio frequency energy harvester to convert RF signals into an energy source.

FIG. 7(E) is a diagram 732 illustrating a second type of an A-IoT device. Device B's design targets lie between those of Device A and Device C in terms of power and complexity. It has energy storage but no independent signal generation, relying on backscattering transmission. Stored energy can be used for signal amplification. Device B also requires a backscattering activation power threshold, experiences reflection loss, and needs a distant carrier wave source for positioning.

### The Architecture of Device B Includes the Following Components

An LPF for suppressing ASCI and ACI;

An ED to support OOK-based signals;

An ADC for digital baseband processing;

A DBB for sequence matching;

A modulator controlled by the incoming signal to add payload data for OOK modulation;

An RF energy harvester to convert RF signals into an energy source;

Additional energy harvesters for different types of ambient power sources, such as RF radio, solar energy, thermal energy, and piezoelectric power;

Energy storage, such as capacitors and solid-state batteries; and

A reflection amplifier to amplify the input signal to the tag and the backscattered signal towards the reader.

FIG. 7(F) is a diagram 734 illustrating a third type of an A-IoT device. Device C is designed with a power consumption target during transmission/reception of ≤1 mW to ≤10 mW, and a complexity target that is orders-of-magnitude lower than NarrowBand IoT (NB-IoT). Device C has energy storage, independent signal generation, and active RF components for transmission. It also has mobility management capabilities, at least for cell selection/re-selection.

### The Architecture of Device C Includes the Following Components

An LPF for suppressing ASCI and ACI;

An ED to support OOK-based signals;

An ADC for digital baseband processing;

A DBB for synchronization, payload decoding, and cyclic redundancy check (CRC)

An RF energy harvester to convert RF signals into an energy source;

Additional energy harvesters for different types of ambient power sources, such as RF radio, solar energy, thermal energy, and piezoelectric power;

Energy storage, such as capacitors and solid-state batteries; and

A low-noise amplifier (LNA) and power amplifier (PA) to amplify reception and transmission signals.

### New Air Interface

FIG. 7(G) is a diagram 740 illustrating an example communication link between a UE such as the UE 744 and an A-IoT device such as the A-IoT device 746 via an air interface. The disclosure presents an innovative air interface for communication between User Equipment (UE) and the Ambient Internet of Things (A-IoT) device. The communication process is initiated when the UE powers up the A-IoT device and transmits a command. This command outlines essential communication parameters such as the tag rate, the tag data encoding method, and the total number of available time durations.

Once the A-IoT device has harvested enough energy, it gets activated and listens for the UE's command. After decoding the command, the A-IoT device randomly selects a time duration from the available range, and generates a random sequence. This sequence is then transmitted in the chosen time duration, preceded by a known preamble sequence.

In response to the A-IoT's transmission, the UE decodes the received preamble sequence and sends an acknowledgment back to the A-IoT within a predetermined duration, aligning with the system's configuration for the A-IoT device.

FIG. 7(H) is a diagram 750 illustrating an example communication process between a reader device and an A-IoT device based on a chosen time duration. The User Equipment to Ambient IoT Device Communication Link (U2A Link) uses modulation schemes like Amplitude Shift Keying (ASK) or On-Off Keying (OOK) to facilitate Pulse Interval Encoding (PIE) for data transmission. The U2A link includes two preambles: a long U2A preamble for initial transmission and a short U2A preamble for subsequent signaling. The UE transmits the long U2A preamble and a control signal or command, specifying control parameters for the A-IoT device.

The Ambient IoT Device to User Equipment Communication Link (A2U Link) employs either ASK or Phase Shift Keying (PSK) modulation. The A-IoT encodes backscattered data using either FMO baseband or Miller modulation, as controlled by the UE or gNB via the A2U link. The A2U link signaling commences with one of two Miller Subcarrier Preambles, depending on the command or the control signal. The A-IoT employs backscatter modulation, altering its antenna's reflection coefficient to transmit data. The A2U link transmits Electronic Product Code (EPC) and Protocol-Control Information (PC).

### Modified 4-Step RACH

Considering that the A-IoT (Ambient IoT) device can only perform ASK (Amplitude Shift Keying) or OOK (On-Off Keying) modulation and backscattering communication, and that the Downlink (DL) signals can be PSS (Primary Synchronization Signal), SSS (Secondary Synchronization Signal), and OOK-based Low Power Wake-Up Signal (LP-WUS), the modified 4-step RACH procedure could be as follows:

1. DL Signal Reception: The A-IoT device listens for the PSS, SSS, or LP-WUS from the gNB or UE reader. These signals serve as an “inquiry command” for the A-IoT device. For example, the LP-WUS, specifically designed to wake up devices from a low-power state, could be particularly useful for A-IoT devices. Upon detecting one of these signals, the A-IoT device wakes up and prepares for further communication.

2. Preamble Transmission (Msg1): Upon receiving the DL signal, the A-IoT device generates a random 16-bit number (RN16) and sends it back to the gNB or UE reader. This is done through backscattering communication, using ASK or OOK modulation. This is similar to the RFID tag sending the RN16 to the reader in response to the inquiry command.

3. Random Access Response (Msg2): The gNB or UE reader sends an acknowledgment signal back to the A-IoT device, which includes the RN16. This acknowledgment could be sent on a specific DL channel that the A-IoT device is programmed to monitor. The A-IoT device, upon receiving this acknowledgment, knows that the gNB or UE reader has successfully received its RN16.

4. RRC Connection Request (Msg3): Once the A-IoT device receives the acknowledgment, it sends its Electronic Product Code (EPC) to the gNB or UE reader. This is done through backscattering communication, using ASK or OOK modulation. This EPC is a unique identifier for the A-IoT device, similar to the unique identifier of an RFID tag.

5. Contention Resolution (Msg4): The gNB or UE reader sends a contention resolution message to the A-IoT device, confirming the A-IoT device's EPC and completing the RACH procedure. This step ensures that the A-IoT device has been correctly identified and that there are no collisions with other A-IoT devices. The contention resolution message could include the EPC of the A-IoT device, so the device knows that the message is intended for it.

This modified 4-step RACH procedure aligns more closely with the RFID protocol, with the A-IoT device acting as the RFID tag and the gNB or UE reader acting as the RFID reader.

FIG. 7(I) is a sequence diagram 760 that describes the modified 4-step RACH procedure. In this diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

### Modified 2-Step RACH

This subsection elucidates a proposed modification to the 2-step Random Access Channel (RACH) procedure, designed to accommodate the characteristics of Ambient Internet of Things (A-IoT) devices. The modification aligns with the RFID protocol and takes into account the A-IoT device's capabilities for Amplitude Shift Keying (ASK) or On-Off Keying (OOK) modulation and backscattering communication.

### The Procedure Comprises Two Main Stages

1. Downlink Signal Transmission and Preamble Transmission (Msg1): The gNB or UE reader initiates the process by transmitting a Downlink (DL) signal, accompanied by a random 16-bit number (RN16), to the A-IoT device. The DL signal could be a Primary Synchronization Signal (PSS), Secondary Synchronization Signal (SSS), or Low Power Wake-Up Signal (LP-WUS), serving as an “inquiry command” for the A-IoT device. For instance, the gNB could dispatch a DL signal (PSS) along with an RN16 (1011 1100 0011 1110). The A-IoT device, upon receiving this signal, harnesses it to charge its battery.

2. Random Access Response and Contention Resolution (Msg2): In the subsequent stage, the A-IoT device validates the received RN16 against its tag ID. Upon a match, the A-IoT device reciprocates by transmitting the RN16 and its unique Electronic Product Code (EPC) to the gNB or UE reader, leveraging backscattering communication with ASK or OOK modulation. To illustrate, if the RN16 aligns with the tag ID of the A-IoT device, the device responds by backscattering the RN16 (1011 1100 0011 1110) and its EPC (e.g., 0000 1010 1111 0000). The gNB or UE reader, upon successful reception of the EPC, completes the RACH procedure by sending a final acknowledgment to the A-IoT device.

This modification to the 2-step RACH procedure brings it closer to the RFID protocol, casting the A-IoT device in the role of the RFID tag and the gNB or UE reader as the RFID reader. However, this is a simplified representation and may not encapsulate all facets of the NR and RFID protocols.

FIG. 7(J) is a sequence diagram 770 that describes a modified 2-step RACH procedure. In this sequence diagram, the “A-IoT device” participant stands for the A-IoT device, and the “gNB/UE reader” participant signifies the gNB or UE reader. The arrows denote the communication between the two participants, while the notes offer additional details about the behavior of each participant at each step of the procedure.

This diagrammatic representation aligns with the modified 2-step RACH procedure, which is designed to mimic the RFID protocol. The A-IoT device acts as the RFID tag and the gNB or UE reader plays the role of the RFID reader. It's important to note that this is a simplified model and might not encapsulate all aspects of the NR and RFID protocols. Real-world implementations could necessitate additional measures to manage errors, retransmissions, and security considerations. This sequence diagram serves as a high-level overview of the procedure, providing a foundation for further detailing based on specific implementation requirements.

### Modified RACH Procedure (UE Acting as a Tag Reader)

FIG. 7(K) is a sequence diagram 780 that describes a modified RACH procedure where a UE acts as a tag reader. As shown in FIG. 7(K), this modification allows a User Equipment (UE), acting as a reader, to communicate with Ambient Internet of Things (A-IoT) devices, acting as tags.

1. Preamble (Query): The UE (acting as the reader) initiates the process by sending a modified RACH preamble. This preamble is broadcast to all tags in its vicinity. This serves as the “Query” in the RFID protocol. The modified preamble could be sent over the Physical Random Access Channel (PRACH). The preamble could contain a specific sequence or pattern that the tags are programmed to recognize. For example, the preamble could start with a specific bit pattern followed by the UE's unique identifier.

The UE's behavior would involve generating the preamble and transmitting it over the PRACH. The UE would need to ensure that the preamble is detectable by the tags, which might require a change in the format or power level of the preamble.

2. Response (RN16): Upon detecting the preamble, each tag generates a random 16-bit number (RN16) and responds with it. This would be similar to the RACH Response in the current procedure. The tags would need to have the capability to generate and transmit this RN16, which is not a feature of traditional RFID tags. This would require modifications to the tag's firmware and possibly hardware. The response could be sent over the Physical Uplink Shared Channel (PUSCH).

The A-IoT device's behavior would involve listening for the preamble on the PRACH, generating the RN16 upon detecting the preamble, and transmitting the RN16 over the PUSCH.

3. Connection Setup (ACK): The UE listens for responses from the tags. Upon receiving a valid RN16 from a tag, the UE sends a modified Connection Setup message to that tag. This serves as the “ACK” in the RFID protocol. The UE would need to be modified to generate and send this ACK message. The ACK message could be sent over the Physical Downlink Control Channel (PDCCH) and could contain the RN16 and a command instructing the tag to transmit its unique identifier.

The UE's behavior would involve listening for the RN16 on the PUSCH, validating the RN16, and transmitting the ACK message over the PDCCH.

4. Data Transmission (EPC): Upon receipt of the ACK message, the tag responds with its unique identifier. This would be similar to the EPC in the RFID protocol. The tag would need to be modified to store its unique identifier and transmit it upon receipt of the ACK message. The unique identifier could be sent over the PUSCH.

The A-IoT device's behavior would involve listening for the ACK message on the PDCCH, extracting the command from the ACK message, and transmitting its unique identifier over the PUSCH.

This would require significant changes to both the UE and the tags, including hardware and firmware modifications.

Absolutely, based on the context provided, FIG. 7(K) illustrates how a part of a technical report might look like with a PlantUML Sequence Diagram.

The proposed modification of the 5G NR RACH procedure allows a User Equipment (UE), acting as a reader, to communicate with Ambient Internet of Things (A-IoT) devices, acting as tags.

### Modified Sidelink Procedure

FIG. 7(L) is a sequence diagram 790 that describes a modified Sidelink procedure. This approach allows a User Equipment (UE), acting as an RFID reader, to interact with Ambient Internet of Things (A-IoT) devices, functioning as RFID tags.

1. Discovery Signal (Query): The UE (acting as the reader) sends a discovery signal to all tags in its vicinity. This serves as the “Query” in the RFID protocol. The discovery signal could be sent over the Physical Sidelink Control Channel (PSCCH). The signal could contain a specific sequence or pattern that the tags are programmed to recognize. For example, the signal could start with a specific bit pattern followed by the UE's unique identifier.

The UE's behavior would involve generating the discovery signal and transmitting it over the PSCCH. The UE would need to ensure that the signal is detectable by the tags, which might require a change in the format or power level of the signal.

2. Discovery Response (RN16): Upon detecting the discovery signal, each tag generates a random 16-bit number (RN16) and responds with it. This would be analogous to the Discovery Response in the current sidelink procedure. The tags would need to be modified to generate and transmit this RN16. The response could be sent over the Physical Sidelink Shared Channel (PSSCH).

The A-IoT device's behavior would involve listening for the discovery signal on the PSCCH, generating the RN16 upon detecting the signal, and transmitting the RN16 over the PSSCH.

3. Sidelink Connection Setup (ACK): The UE listens for responses from the tags. Upon receiving a valid RN16 from a tag, the UE sends a Sidelink Connection Setup message to that tag. This serves as the “ACK” in the RFID protocol. The UE would need to be modified to generate and send this ACK message. The ACK message could be sent over the PSCCH and could contain the RN16 and a command instructing the tag to transmit its unique identifier.

The UE's behavior would involve listening for the RN16 on the PSSCH, validating the RN16, and transmitting the ACK message over the PSCCH.

4. Data Transmission (EPC): Upon receipt of the ACK message, the tag responds with its unique identifier. This would be similar to the EPC in the RFID protocol. The tag would need to be modified to store its unique identifier and transmit it upon receipt of the ACK message. The unique identifier could be sent over the PSSCH.

The A-IoT device's behavior would involve listening for the ACK message on the PSCCH, extracting the command from the ACK message, and transmitting its unique identifier over the PSSCH.

This would require significant changes to both the UE and the tags, including hardware and firmware modifications.

FIG. 7(L) illustrates a part of a technical report with a PlantUML Sequence Diagram.

To harness the power of 5G New Radio (NR) for RFID-like communication, the present disclosure proposes a modified Sidelink procedure. This approach allows a User Equipment (UE), acting as an RFID reader, to interact with Ambient Internet of Things (A-IoT) devices, functioning as RFID tags.

### Uncertainty on Battery Level

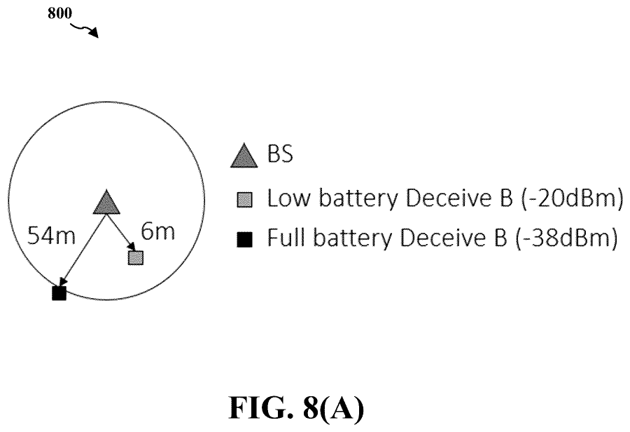

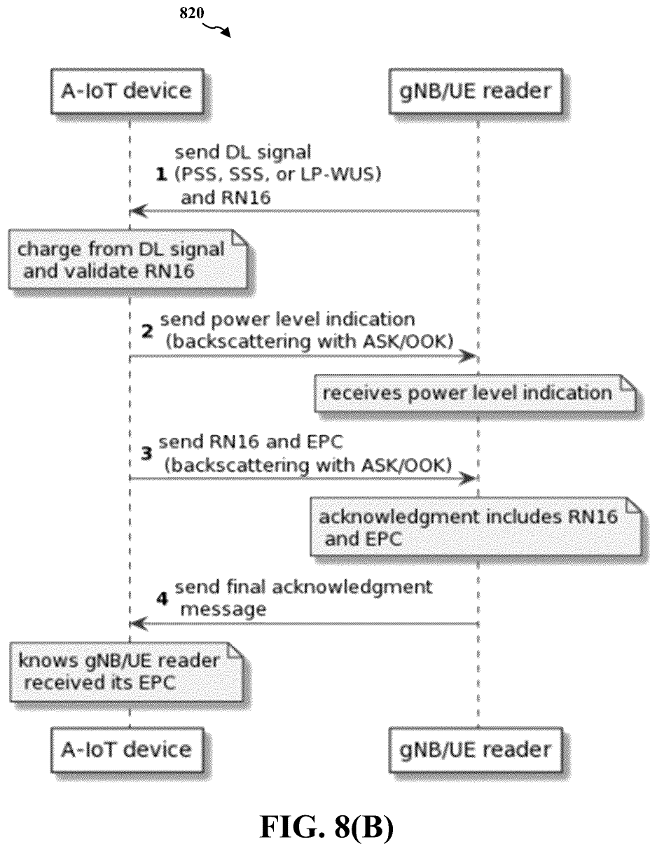

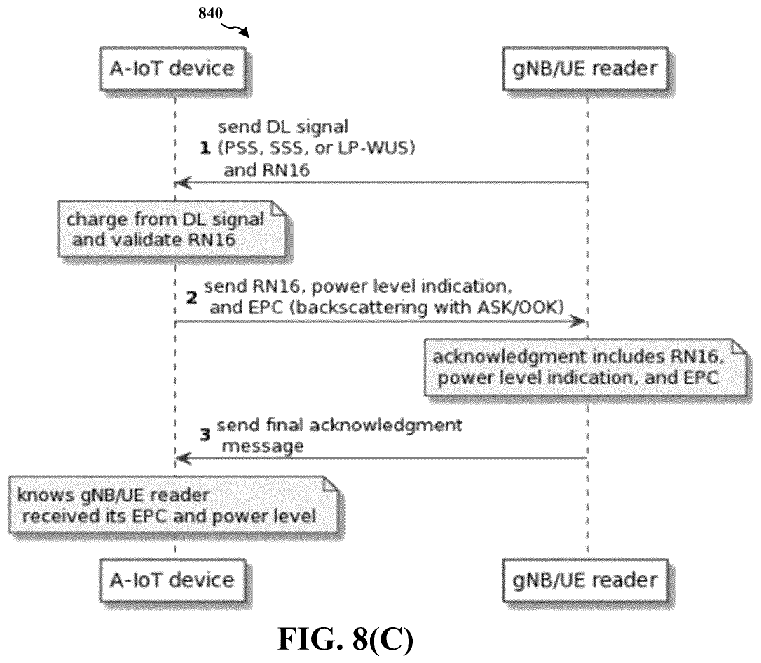

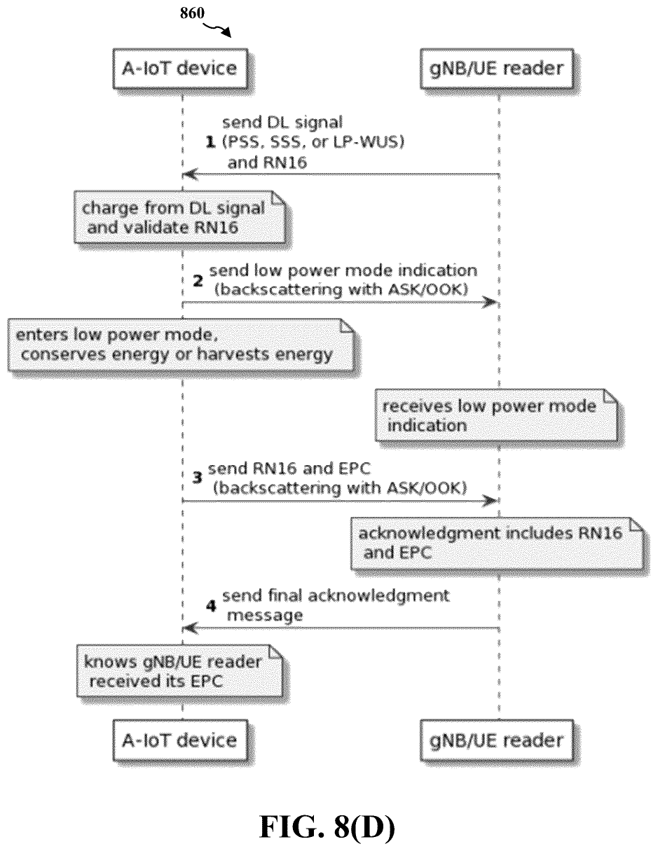

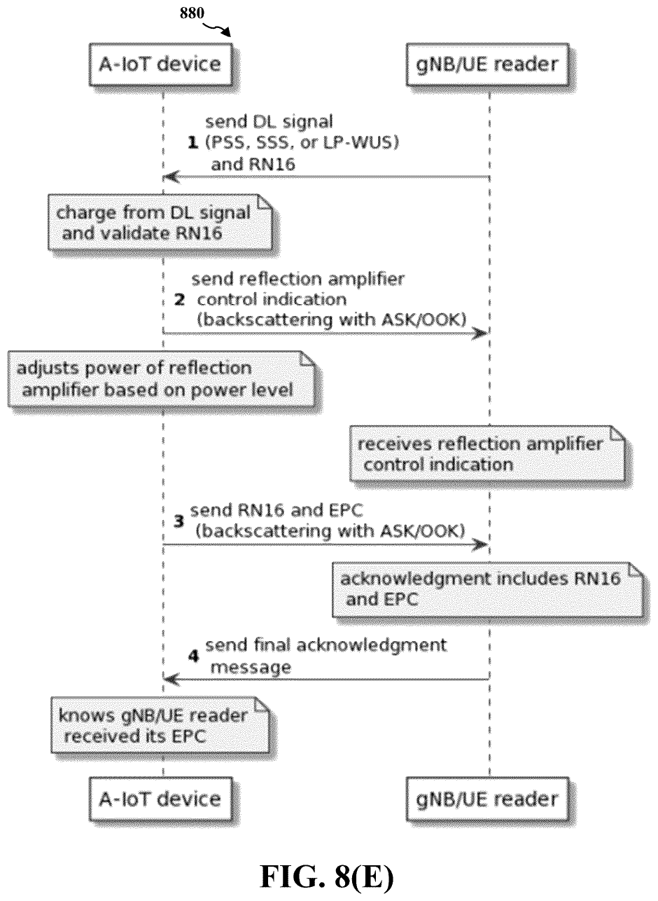

FIG. 8(A) is a diagram 800 illustrating an issue of uncertainty on battery level. For Device B, the device's activation threshold depends on the rectifier's activation threshold in the RF energy harvester. If the device has an amplifier, which requires higher power consumption, RF signal energy harvesting may not be suitable due to its relatively low energy density. This results in uncertainty for the base station to discover Device B in a cell, especially when the device has low battery level or no battery.

This uncertainty in the device's discoverability due to fluctuating battery levels poses a significant challenge in the device's operation and the overall effectiveness of the Ambient Internet of Things (A-IoT) system. Therefore, it's crucial to address this concern and find a solution that ensures consistent device discoverability and reliable communication, regardless of the device's battery levels.

Based on the given A-IoT protocol, here are some potential solutions to ensure consistent device discoverability and reliable communication, regardless of the device's battery levels.

### Power Level Indication

Include a power level indication in the response from the A-IoT device to the UE. This solution is quite feasible as it only requires minor changes to the existing communication protocol.

FIG. 8(B) is a sequence diagram 820 that describes a modified 4-step RACH procedure regarding power level indication. To incorporate a power level indication in the response from the A-IoT device to the UE, the modified 4-step RACH procedure can be adjusted as follows:

1. DL Signal Transmission and Preamble Transmission (Msg1): The gNB or UE reader sends a DL signal, which could be the PSS (Primary Synchronization Signal), SSS (Secondary Synchronization Signal), or LP-WUS (Low Power Wake-Up Signal), along with a random 16-bit number (RN16) to the A-IoT device. This DL signal serves as an “inquiry command” for the A-IoT device. The A-IoT device uses the DL signal to charge its battery.

2. Power Level Indication (Msg2): The A-IoT device measures its current power level and includes this information in its response. The power level indication could be a simple binary value indicating whether the power level is above or below a certain threshold, or it could be a more detailed measurement.

3. Random Access Response and Contention Resolution (Msg3): Upon receiving the DL signal and RN16, the A-IoT device checks if the RN16 matches its tag ID. If it does, then the A-IoT device sends back the RN16, its power level indication, and its unique Electronic Product Code (EPC) to the gNB or UE reader using backscattering communication with ASK or OOK modulation.

4. Final Acknowledgment (Msg4): The gNB or UE reader, upon successful reception of the EPC and power level indication, completes the RACH procedure by sending a final acknowledgment to the A-IoT device.

This modification to the 4-step RACH procedure allows the gNB or UE reader to receive a power level indication from the A-IoT device, which can be used to manage the power levels of the A-IoT devices and ensure efficient communication.

In the context of the modified 4-step RACH procedure for A-IoT devices with power level indication, a sequence diagram can be developed to illustrate the behavior of the A-IoT device and the gNB or UE reader, and the signaling between them. The sequence diagram is illustrated below:

In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

FIG. 8(C) is a sequence diagram 840 that describes a modified 2-step RACH procedure regarding power level indication. To incorporate a power level indication in the response from the A-IoT device to the UE, the modified 2-step RACH procedure can be adjusted as follows:

1. DL Signal Transmission and Preamble Transmission (Msg1): The gNB or UE reader sends a DL signal, which could be the PSS (Primary Synchronization Signal), SSS (Secondary Synchronization Signal), or LP-WUS (Low Power Wake-Up Signal), along with a random 16-bit number (RN16) to the A-IoT device. This DL signal serves as an “inquiry command” for the A-IoT device. The A-IoT device uses the DL signal to charge its battery.

2. Random Access Response, Power Level Indication, and Contention Resolution (Msg2): Upon receiving the DL signal and RN16, the A-IoT device checks if the RN16 matches its tag ID. If it does, then the A-IoT device measures its current power level and includes this power level indication in its response. The A-IoT device sends back the RN16, its power level indication, and its Electronic Product Code (EPC) to the gNB or UE reader using backscattering communication with ASK or OOK modulation. The gNB or UE reader then sends a final acknowledgment to the A-IoT device, confirming the successful reception of the EPC and the power level indication, and completing the RACH procedure.

This modification to the 2-step RACH procedure allows the gNB or UE reader to receive a power level indication from the A-IoT device, which can be used to manage the power levels of the A-IoT devices and ensure efficient communication.

In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

In general, a Power Level Indication Could Include

1. Signal Strength Indicator: This is a numerical value that represents the strength of the received signal. It is often measured in decibels relative to a reference level (dBm).

2. Quality Indicator: This is a measure of the quality of the signal, which can be affected by factors such as interference, noise, and distortion. It is often expressed as a Signal-to-Noise Ratio (SNR) or a Bit Error Rate (BER).

3. Binary Indicator: In some cases, the power level indication could be a simple binary value indicating whether the power level is above or below a certain threshold.

4. Battery Level: For battery-powered devices like A-IoT devices, the power level indication could also include a measure of the remaining battery life. This could help the network make decisions about power management and scheduling.

These measures can help the network or the receiving device make informed decisions about resource allocation, power management, and other aspects of communication.

In the context of the modified 2-step or 4-step RACH procedure, the gNB or UE reader can configure the power level indication from the A-IoT device as follows:

1. DL Signal Transmission and Preamble Transmission (Msg1): The gNB or UE reader sends a DL signal along with a random 16-bit number (RN16) to the A-IoT device. This DL signal could also include instructions for how the A-IoT device should measure and report its power level.

2. Power Level Indication (Msg2): Upon receiving the DL signal and RN16, the A-IoT device measures its current power level according to the instructions received and includes this power level indication in its response. This step is specific to the 4-step RACH procedure.

3. Random Access Response and Contention Resolution (Msg2 or Msg3): The A-IoT device sends back the RN16, its power level indication, and its unique Electronic Product Code (EPC) to the gNB or UE reader. In the 2-step RACH procedure, the power level indication is included in this step instead.

4. Configuration and Final Acknowledgment (Msg3 or Msg4): Upon receiving the power level indication, the gNB or UE reader can configure its transmission power, modulation and coding scheme, or scheduling decisions based on the indicated power level. The gNB or UE reader then sends a final acknowledgment to the A-IoT device, confirming successful reception of the EPC and the power level indication, and completing the RACH procedure.

This modification to the RACH procedure allows the gNB or UE reader to configure the power level indication from the A-IoT device and optimize the communication.

### Low Power Mode

Introduce a low power mode for the A-IoT device. This solution is feasible and can be implemented with minor changes to the device's power management system.

The introduction of a low power mode for Ambient Internet of Things (A-IoT) devices can significantly enhance their energy efficiency. This modification, requiring minor changes to the device's power management system, not only prolongs the device's operational lifespan, but also provides additional processing time for power-saving measures and energy harvesting, meeting the diverse needs of different A-IoT device behaviors.

The modified 2-step or 4-step Random Access Channel (RACH) procedure can be adapted to facilitate this low power mode as follows:

1. DL Signal Transmission and Preamble Transmission (Msg1): The gNB or UE reader sends a DL signal, potentially a Primary Synchronization Signal (PSS), Secondary Synchronization Signal (SSS), or Low Power Wake-Up Signal (LP-WUS), along with a random 16-bit number (RN16) to the A-IoT device. This signal acts as an “inquiry command” for the A-IoT device. The A-IoT device uses this signal to charge its battery or store energy for future use.

2. Low Power Mode Indication (Msg2): In the 4-step RACH procedure, the A-IoT device measures its current power level. If it falls below a certain threshold, the device switches to low power mode. Depending on the specific behavior of the A-IoT device, it may either enter a standby state, reduce the power consumption of non-essential components, or perform other power-saving measures. This mode also provides more processing time for the A-IoT device to save power or harvest energy from the environment. The device then includes this low power mode indication in its response.

3. Random Access Response and Contention Resolution (Msg2 or Msg3): Upon receiving the DL signal and RN16, the A-IoT device validates the RN16 against its tag ID. If there's a match, the device sends back the RN16, its low power mode indication, and its unique Electronic Product Code (EPC) to the gNB or UE reader. In the 2-step RACH procedure, the low power mode indication is included in this step.

4. Final Acknowledgment (Msg3 or Msg4): Upon successful reception of the EPC and low power mode indication, the gNB or UE reader completes the RACH procedure by sending a final acknowledgment to the A-IoT device.

FIG. 8(D) is a sequence diagram 860 that describes a modified RACH procedure regarding low power mode. By incorporating a low power mode in the A-IoT device, it can significantly enhance its energy efficiency, especially during idle or low-activity periods. This is particularly advantageous for A-IoT devices with different behaviors, as it allows for flexible power management strategies that can be tailored to the specific needs and characteristics of each device.

In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

Upon sending the low power mode indication to the gNB or UE reader, the A-IoT device enters low power mode. Depending on the specific behavior of the A-IoT device, it may either enter a standby state, reduce the power consumption of non-essential components, or perform other power-saving measures. This mode also provides more processing time for the A-IoT device to save power or harvest energy from the environment.

### Controlled Reflection Amplifier

The A-IoT device can adjust the power consumption of its reflection amplifier based on its current power level. This solution is feasible, but it requires the device to have a controllable reflection amplifier.

The adjustment of the power consumption of the reflection amplifier in Ambient Internet of Things (A-IoT) devices, based on their current power level, can significantly enhance their energy efficiency. This modification, which requires the device to have a controllable reflection amplifier, can extend the device's operational lifespan and provide additional processing time for power-saving measures and energy harvesting, meeting the diverse needs of different A-IoT device behaviors.

The modified 2-step or 4-step Random Access Channel (RACH) procedure can be adapted to facilitate this controllable reflection amplifier as follows:

1. DL Signal Transmission and Preamble Transmission (Msg1): The gNB or UE reader sends a DL signal, potentially a Primary Synchronization Signal (PSS), Secondary Synchronization Signal (SSS), or Low Power Wake-Up Signal (LP-WUS), along with a random 16-bit number (RN16) to the A-IoT device. This signal acts as an “inquiry command” for the A-IoT device. The A-IoT device uses this signal to charge its battery or store energy for future use.

2. Reflection Amplifier Control Indication (Msg2): In the 4-step RACH procedure, the A-IoT device measures its current power level. If it falls below a certain threshold, the device adjusts the power consumption of its reflection amplifier. Depending on the specific behavior of the A-IoT device, it may either increase or decrease the power consumption of the reflection amplifier to optimize its performance. The device then includes this reflection amplifier control indication in its response.

3. Random Access Response and Contention Resolution (Msg2 or Msg3): Upon receiving the DL signal and RN16, the A-IoT device validates the RN16 against its tag ID. If there's a match, the device sends back the RN16, its reflection amplifier control indication, and its unique Electronic Product Code (EPC) to the gNB or UE reader. In the 2-step RACH procedure, the reflection amplifier control indication is included in this step.

4. Final Acknowledgment (Msg3 or Msg4): Upon successful reception of the EPC and reflection amplifier control indication, the gNB or UE reader completes the RACH procedure by sending a final acknowledgment to the A-IoT device.

By incorporating a controllable reflection amplifier in the A-IoT device, it can significantly enhance its energy efficiency, especially during idle or low-activity periods. This is particularly advantageous for A-IoT devices with different behaviors, as it allows for flexible power management strategies that can be tailored to the specific needs and characteristics of each device.

In the context of the modified 2-step or 4-step RACH procedure for A-IoT devices with a controllable reflection amplifier, a sequence diagram can be developed to illustrate the behavior of the A-IoT device and the gNB or UE reader, and the signaling between them.

FIG. 8(E) is a sequence diagram 880 that describes a modified RACH procedure regarding a controllable reflection amplifier. In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

Upon sending the reflection amplifier control indication to the gNB or UE reader, the A-IoT device adjusts the power consumption of its reflection amplifier. Depending on the specific behavior of the A-IoT device, it may either increase or decrease the power consumption of the reflection amplifier to optimize its performance.

### Dedicated RF Charging Source

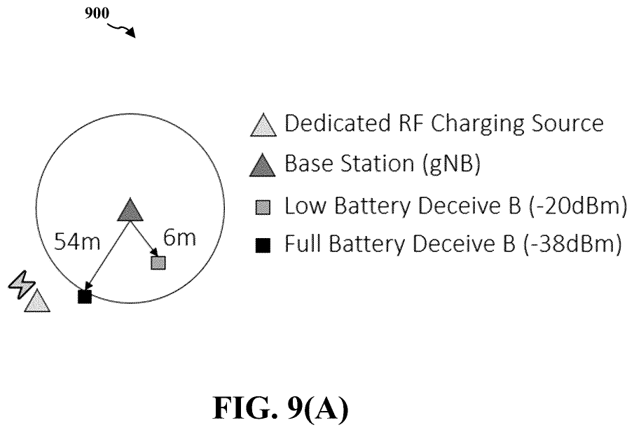

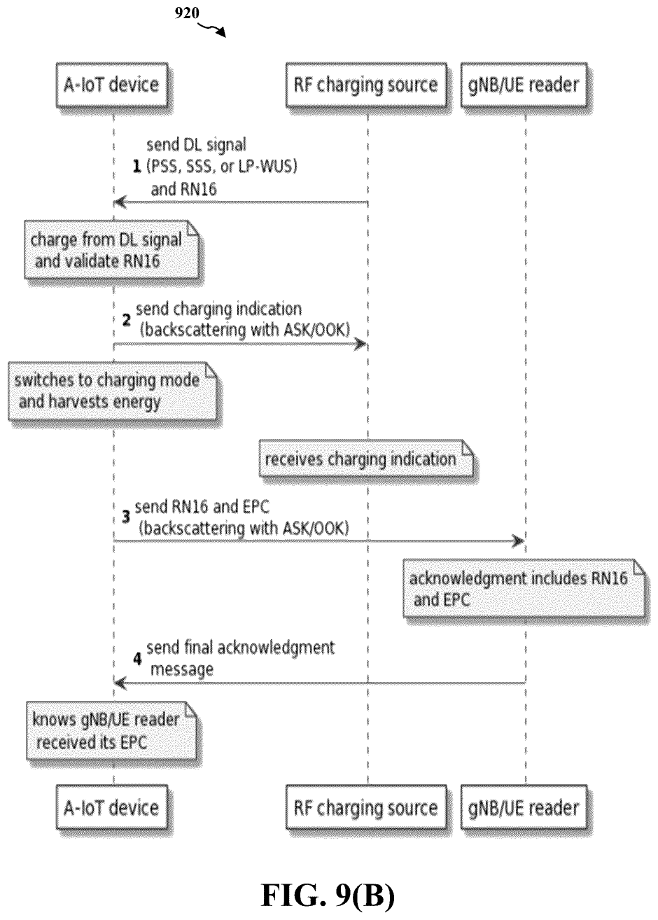

FIG. 9(A) is a diagram 900 that describes introduction of a dedicated RF source that focuses on charging the A-IoT devices.

The introduction of a dedicated RF source that focuses on charging Ambient Internet of Things (A-IoT) devices can significantly enhance their energy efficiency. This solution, although requiring additional infrastructure, could significantly boost the power levels of the A-IoT devices, thereby extending their operational lifespan and providing additional processing time for power-saving measures and energy harvesting, meeting the diverse needs of different A-IoT device behaviors.

The modified 2-step or 4-step Random Access Channel (RACH) procedure can be adapted to facilitate this dedicated RF charging source as follows:

1. DL Signal Transmission and Preamble Transmission (Msg1): The dedicated RF source sends a DL signal, potentially a Primary Synchronization Signal (PSS), Secondary Synchronization Signal (SSS), or Low Power Wake-Up Signal (LP-WUS), along with a random 16-bit number (RN16) to the A-IoT device. This signal acts as a “charging command” for the A-IoT device. The A-IoT device uses this signal to charge its battery or store energy for future use.

2. Charging Indication (Msg2): In the 4-step RACH procedure, the A-IoT device measures its current power level. If it falls below a certain threshold, the device switches to charging mode and starts harvesting energy from the dedicated RF source. The device then includes this charging indication in its response.

3. Random Access Response and Contention Resolution (Msg2 or Msg3): Upon receiving the DL signal and RN16 from the dedicated RF source, the A-IoT device validates the RN16 against its tag ID. If there's a match, the device sends back the RN16, its charging indication, and its unique Electronic Product Code (EPC) to the dedicated RF source. In the 2-step RACH procedure, the charging indication is included in this step.

4. Final Acknowledgment (Msg3 or Msg4): Upon successful reception of the EPC and charging indication, the dedicated RF source completes the RACH procedure by sending a final acknowledgment to the A-IoT device.

During this process, the A-IoT device may not be able to receive signals from both the dedicated RF charging source and the gNB or UE reader simultaneously due to potential interference or resource constraints. Therefore, it might need to switch between the two sources based on its current power level and operational requirements.

By incorporating a dedicated RF charging source, A-IoT devices can significantly enhance their energy efficiency, especially during idle or low-activity periods. This is particularly advantageous for A-IoT devices with different behaviors, as it allows for flexible power management strategies that can be tailored to the specific needs and characteristics of each device.

In the context of the modified 2-step or 4-step RACH procedure for A-IoT devices with a dedicated RF charging source, a sequence diagram can be developed to illustrate the behavior of the A-IoT device, the gNB or UE reader, and the dedicated RF charging source, and the signaling between them.

FIG. 9(B) is a sequence diagram 920 that describes a modified RACH procedure regarding a dedicated RF charging source. In this sequence diagram, the “A-IoT device” participant represents the A-IoT device, the “RF charging source” participant represents the dedicated RF charging source, and the “gNB/UE reader” participant represents the gNB or UE reader. The arrows represent the communication between the three participants, and the notes provide additional information about the behavior of each participant at each step of the procedure.

### Smart RF Charging Scheduling

The implementation of a smart scheduling system, where the RF charging source is only active during periods of low communication activity, can significantly enhance the energy efficiency of Ambient Internet of Things (A-IoT) devices. This solution, which requires intelligent scheduling algorithms and coordination with the communication channels, could significantly boost the power levels of the A-IoT devices, thereby extending their operational lifespan and providing additional processing time for power-saving measures and energy harvesting, meeting the diverse needs of different A-IoT device behaviors.

The modified 2-step or 4-step Random Access Channel (RACH) procedure can be adapted to facilitate this smart RF charging scheduling as follows:

1. DL Signal Transmission and Preamble Transmission (Msg1): The dedicated RF source sends a DL signal, potentially a Primary Synchronization Signal (PSS), Secondary Synchronization Signal (SSS), or Low Power Wake-Up Signal (LP-WUS), along with a random 16-bit number (RN16) to the A-IoT device. This signal acts as a “charging command” for the A-IoT device. The A-IoT device uses this signal to charge its battery or store energy for future use.

2. Charging Schedule Indication (Msg2): In the 4-step RACH procedure, the A-IoT device measures its current power level. If it falls below a certain threshold, the device switches to charging mode and starts harvesting energy from the dedicated RF source. The device then includes this charging schedule indication in its response.

3. Random Access Response and Contention Resolution (Msg2 or Msg3): Upon receiving the DL signal and RN16 from the dedicated RF source, the A-IoT device validates the RN16 against its tag ID. If there's a match, the device sends back the RN16, its charging schedule indication, and its unique Electronic Product Code (EPC) to the dedicated RF source. In the 2-step RACH procedure, the charging schedule indication is included in this step.

4. Final Acknowledgment (Msg3 or Msg4): Upon successful reception of the EPC and charging schedule indication, the dedicated RF source completes the RACH procedure by sending a final acknowledgment to the A-IoT device.

During this process, the A-IoT device may not be able to receive signals from both the dedicated RF charging source and the gNB or UE reader simultaneously due to potential interference or resource constraints. Therefore, it might need to switch between the two sources based on its current power level and operational requirements.

By incorporating a smart RF charging scheduling system, A-IoT devices can significantly enhance their energy efficiency, especially during idle or low-activity periods. This is particularly advantageous for A-IoT devices with different behaviors, as it allows for flexible power management strategies that can be tailored to the specific needs and characteristics of each device.

### Cooperative Device Discovery

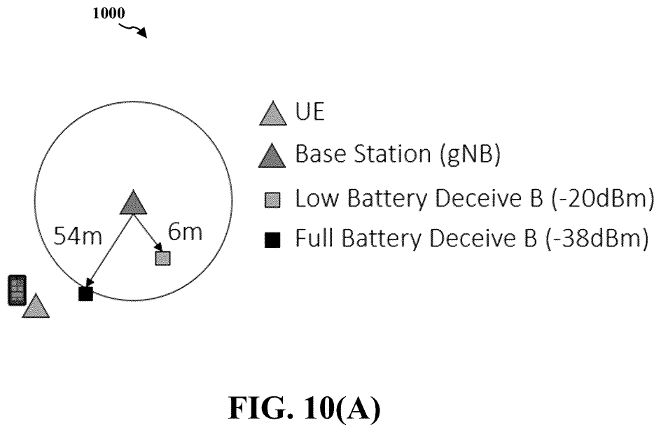

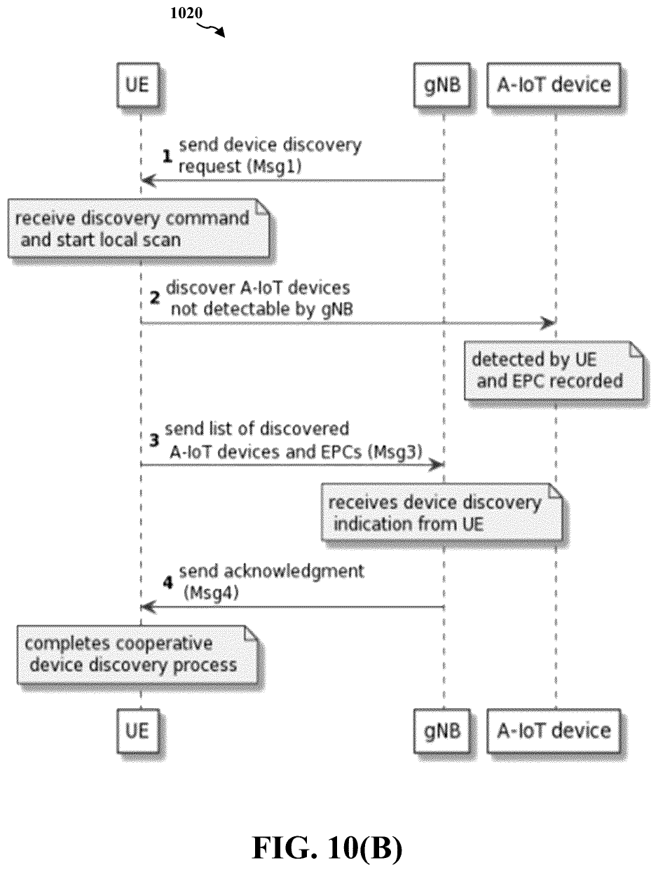

FIG. 10(A) is a diagram 1000 that describes implementation of a cooperative device discovery protocol where A-IoT devices help the gNB or UE discover other A-IoT devices.

The implementation of a cooperative device discovery protocol, where User Equipment (UE) assists the gNB in discovering Ambient Internet of Things (A-IoT) devices that are not directly detectable by the gNB, can significantly enhance network efficiency and device detection. This solution, which requires changes to the device discovery protocol and may increase the complexity of the network, could improve the network's ability to detect and communicate with A-IoT devices, thereby enhancing the overall performance and reliability of the A-IoT network.

In a cooperative device discovery protocol, UEs not only communicate with a gNB but also help to discover other A-IoT devices within their vicinity. This can be facilitated through a modified process as follows:

1. Device Discovery Request (Msg1): The gNB sends a device discovery request to a known UE. This request acts as a “discovery command” for the UE.

2. Device Discovery Assistance (Msg2): Upon receiving the device discovery request, the UE starts a local scan to discover other A-IoT devices within its vicinity that are not directly detectable by the gNB. It then prepares a list of discovered devices, including their unique Electronic Product Codes (EPCs).

3. Device Discovery Response (Msg3): The UE sends back the list of discovered A-IoT devices, along with their EPCs, to the gNB. This response acts as a device discovery indication.

4. Acknowledgment (Msg4): Upon successful reception of the device discovery indication, the gNB sends an acknowledgment to the UE, completing the cooperative device discovery process.

By incorporating a cooperative device discovery protocol, UEs can significantly enhance their network efficiency, especially in densely populated or complex network environments. This is particularly advantageous for A-IoT networks, as it allows for flexible device discovery strategies that can help to detect and communicate with a larger number of devices, even in challenging environments.

FIG. 10(B) is a sequence diagram 1020 that illustrates the behavior of the UE, the gNB, and the A-IoT devices, and the signaling between them in the context of a cooperative device discovery protocol for A-IoT devices. In this sequence diagram, the “UE” participant represents the User Equipment, the “gNB” participant represents the gNB, and the “A-IoT device” participant represents the A-IoT devices that are not directly detectable by the gNB. The arrows represent the communication between the three participants, and the notes provide additional information about the behavior of each participant at each step of the procedure.

Upon receiving the device discovery request from the gNB, the UE starts a local scan to discover other A-IoT devices within its vicinity. The UE then sends back the list of discovered A-IoT devices, along with their EPCs, to the gNB. Upon successful reception of the device discovery indication, the gNB sends an acknowledgment to the UE, completing the cooperative device discovery process.

### Coordinated Charging and Communication

The implementation of coordinated charging and communication, where the gNB and a dedicated RF charging source coordinate their operations to ensure efficient charging and communication with Ambient Internet of Things (A-IoT) devices, can significantly enhance network efficiency and energy management. This solution, which requires coordination algorithms and changes to the operation of the gNB and the charging source, could improve the network's ability to detect, communicate with, and power A-IoT devices, thereby enhancing the overall performance and reliability of the A-IoT network.

In a coordinated charging and communication protocol, the gNB and the RF charging source not only independently communicate with A-IoT devices but also coordinate their operations to optimize device charging and communication. This can be facilitated through a modified process as follows:

1. DL Signal Transmission and Preamble Transmission (Msg1): The gNB or RF charging source sends a DL signal, potentially a Primary Synchronization Signal (PSS), Secondary Synchronization Signal (SSS), or Low Power Wake-Up Signal (LP-WUS), along with a random 16-bit number (RN16) to the A-IoT device.

2. Charging and Communication Coordination (Msg2): Upon receiving the DL signal and RN16, the A-IoT device measures its current power level and communication needs. The device then sends a coordination request to the gNB and the RF charging source, indicating its charging and communication needs.

3. Random Access Response and Contention Resolution (Msg3): Upon receiving the coordination request, the gNB and the RF charging source coordinate their operations to meet the charging and communication needs of the A-IoT device. The gNB and the RF charging source then send a coordination response to the A-IoT device, indicating the coordinated charging and communication plan.

4. Acknowledgment (Msg4): Upon successful reception of the coordination response, the A-IoT device sends an acknowledgment to the gNB and the RF charging source, completing the coordinated charging and communication process.

By incorporating a coordinated charging and communication protocol, A-IoT devices can significantly enhance their network efficiency and energy management, especially in densely populated or complex network environments. This is particularly advantageous for A-IoT networks, as it allows for flexible device charging and communication strategies that can help to optimize device operation, even in challenging environments.

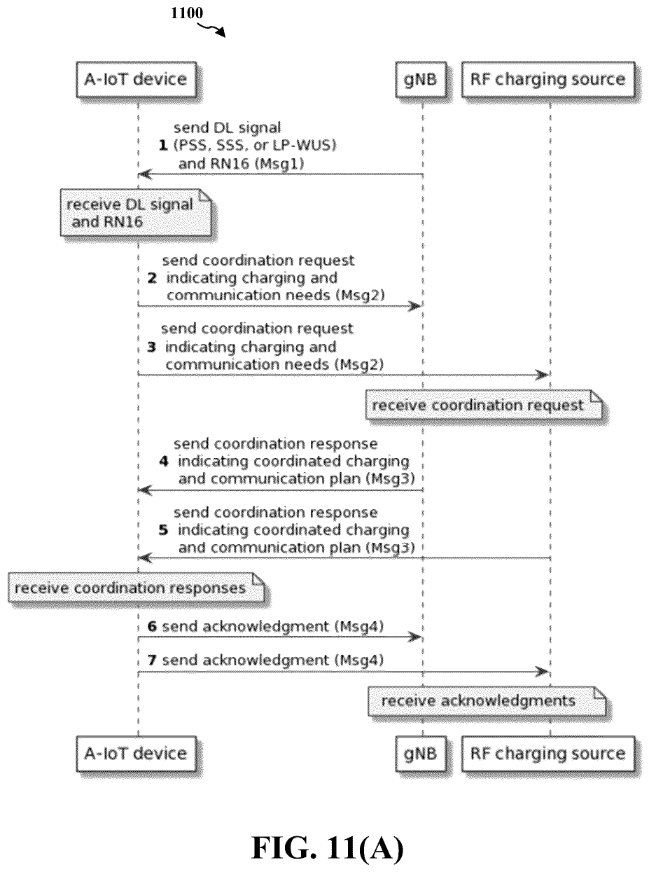

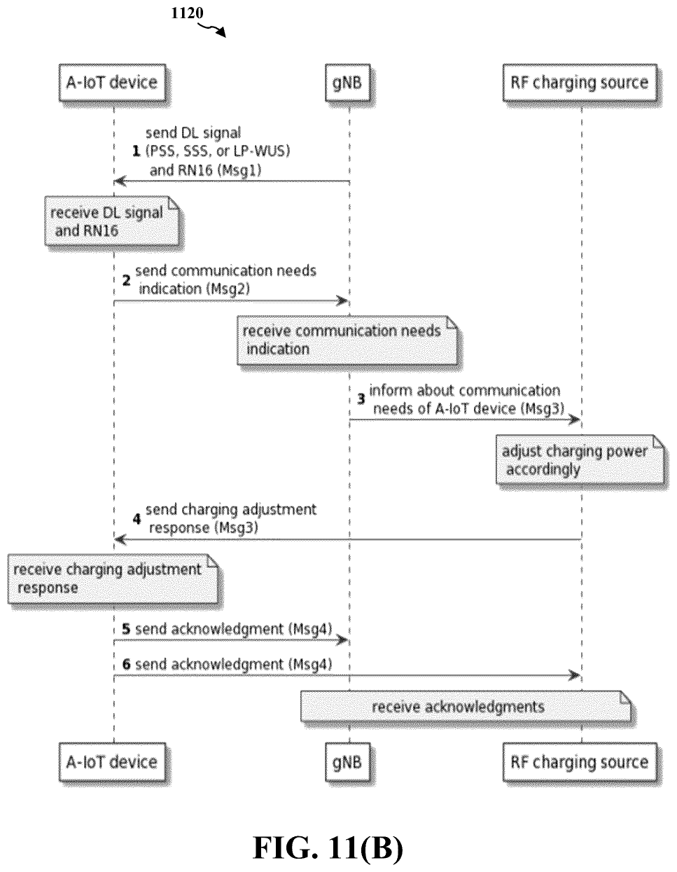

FIG. 11(A) is a sequence diagram 1100 that illustrates the behavior of the A-IoT device, the gNB, the RF charging source, and the signaling between them in the context of a coordinated charging and communication protocol for A-IoT devices.

### Charging Based on Communication Needs

The implementation of charging based on communication needs, where the gNB informs a dedicated RF charging source about the communication needs of the Ambient Internet of Things (A-IoT) devices, and the charging source adjusts its charging power accordingly, can significantly enhance network efficiency and energy management. This solution, which requires communication between the gNB and the charging source and changes to their operation, could improve the network's ability to power A-IoT devices based on their communication needs, thereby enhancing the overall performance and reliability of the A-IoT network.

In a charging protocol based on communication needs, the gNB and the RF charging source not only independently communicate with A-IoT devices but also coordinate their operations to optimize device charging based on communication needs. This can be facilitated through a modified process as follows:

1. DL Signal Transmission and Preamble Transmission (Msg1): The gNB sends a DL signal, potentially a Primary Synchronization Signal (PSS), Secondary Synchronization Signal (SSS), or Low Power Wake-Up Signal (LP-WUS), along with a random 16-bit number (RN16) to the A-IoT device.

2. Communication Needs Indication (Msg2): Upon receiving the DL signal and RN16, the A-IoT device measures its current communication needs. The device then sends a communication needs indication to the gNB, indicating its communication needs.

3. Communication Needs Response and Charging Adjustment (Msg3): Upon receiving the communication needs indication, the gNB informs the RF charging source about the communication needs of the A-IoT device. The RF charging source then adjusts its charging power accordingly and sends a charging adjustment response to the A-IoT device.

4. Acknowledgment (Msg4): Upon successful reception of the charging adjustment response, the A-IoT device sends an acknowledgment to the gNB and the RF charging source, completing the charging based on communication needs process.

By incorporating a charging protocol based on communication needs, A-IoT devices can significantly enhance their network efficiency and energy management, especially in densely populated or complex network environments. This is particularly advantageous for A-IoT networks, as it allows for flexible device charging strategies that can help to optimize device operation, even in challenging environments.

FIG. 11(B) is a sequence diagram 1120 that illustrates the behavior of the A-IoT device, the gNB, the RF charging source, and the signaling between them in the context of a charging protocol based on communication needs for A-IoT devices.

### Power-Aware Modulation Techniques

The implementation of power-aware modulation techniques, where Ambient Internet of Things (A-IoT) devices adjust the type of modulation based on their remaining power level, can significantly enhance network efficiency and energy management. This solution, which requires changes to the modulation techniques used by the device, could improve the network's ability to sustain A-IoT devices' operations, thereby enhancing the overall performance and reliability of the A-IoT network.

In a power-aware modulation protocol, A-IoT devices not only communicate with a gNB but also adjust their modulation type during the RACH process. This can be facilitated through a generalized RACH process as follows:

1. DL Signal Reception: The A-IoT device listens for the PSS, SSS, or LP-WUS from the gNB or UE reader. These signals serve as an “inquiry command” for the A-IoT device.

2. Preamble Transmission (Msg1): Upon receiving the DL signal, the A-IoT device generates a random 16-bit number (RN16) and sends it back to the gNB or UE reader. This is done through backscattering communication, using ASK or OOK modulation. The modulation type is adjusted based on the remaining power level.

3. Random Access Response (Msg2): The gNB or UE reader sends an acknowledgment signal back to the A-IoT device, which includes the RN16.

4. RRC Connection Request (Msg3): Once the A-IoT device receives the acknowledgment, it sends its Electronic Product Code (EPC) to the gNB or UE reader. This is done through backscattering communication, using the adjusted modulation type.

5. Contention Resolution (Msg4): The gNB or UE reader sends a contention resolution message to the A-IoT device, confirming the A-IoT device's EPC and completing the RACH procedure.

By incorporating power-aware modulation techniques, A-IoT devices can significantly enhance their network efficiency and energy management, especially in power-constrained environments. This is particularly advantageous for A-IoT networks, as it allows for flexible power management strategies that can help to optimize device operation, even in challenging environments.

Here are two different examples of ASK modulation that require different power consumptions:

1. Binary ASK: This is the simplest form of ASK modulation. In binary ASK, two different amplitudes of the carrier signal are used to represent the binary data. The higher amplitude represents binary ‘1’, and the lower amplitude represents binary ‘0’. This modulation type requires less power consumption.

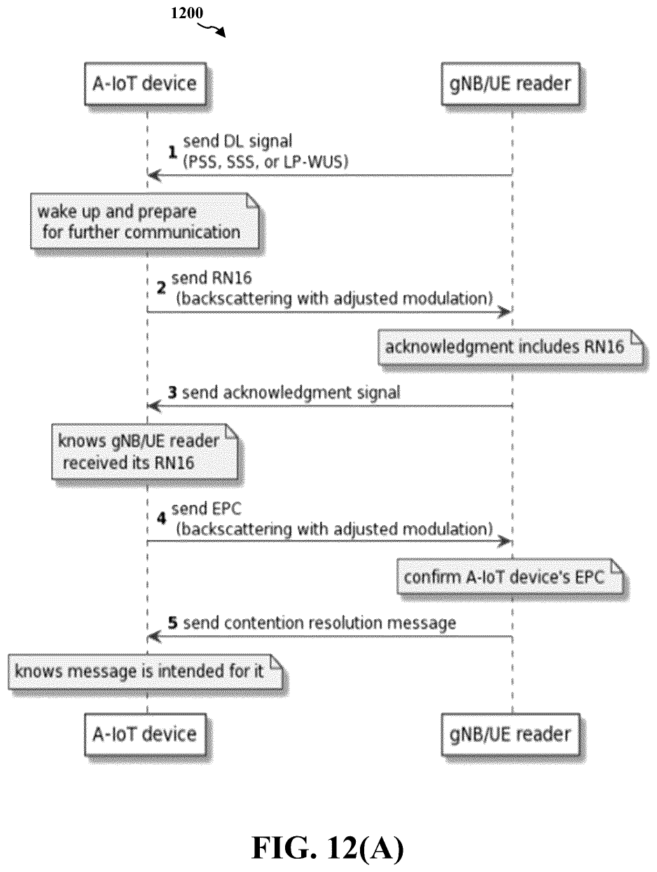

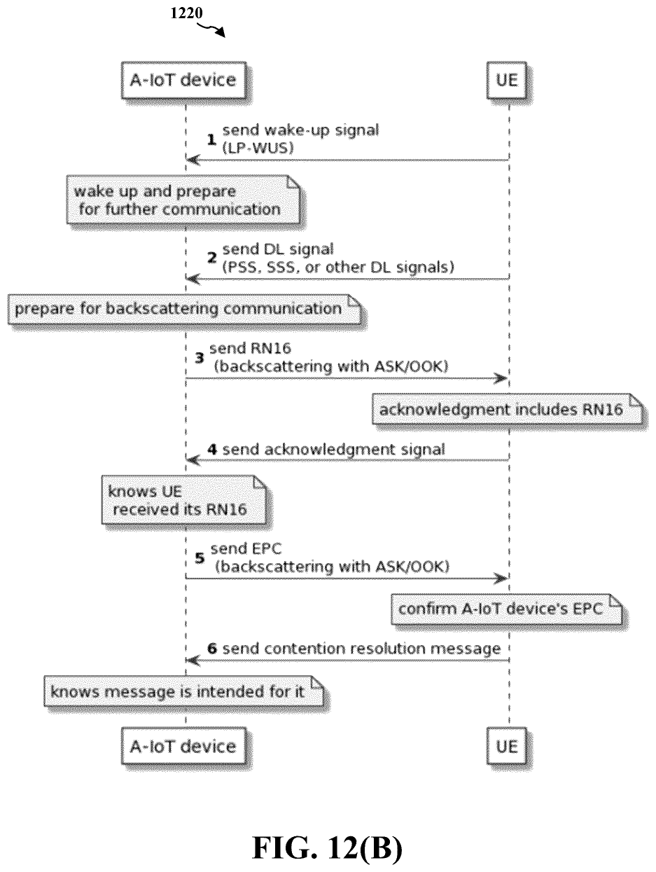

2. Quadrature ASK: This is a more complex form of ASK modulation. In quadrature ASK, four different amplitudes of the carrier signal are used to represent the binary data. Each amplitude can represent two bits of data (00, 01, 10, or 11). This modulation type requires more power consumption due to the increased complexity. FIG. 12(A) is a sequence diagram 1200 for a power-aware modulation protocol. In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

### Passive Wake-Up Mechanism

Implementing a passive wake-up mechanism, where the Ambient Internet of Things (A-IoT) device remains in a low-power sleep mode until it receives a specific signal from the User Equipment (UE), can significantly enhance energy efficiency. This solution, which necessitates changes to the device's power management system, may increase the device's complexity but has the potential to prolong the device's operational lifespan and provide additional processing time for power-saving measures and energy harvesting.

The passive wake-up protocol can be outlined through a modified communication process, as follows:

1. Sleep Mode: The A-IoT device stays in a low-power sleep mode to conserve energy. This mode is maintained until the device receives a specific signal from the UE.

2. Wake-Up Signal Reception: Upon receiving a specific signal from the UE, such as a Low Power Wake-Up Signal (LP-WUS), the A-IoT device wakes up and prepares for further communication. The LP-WUS serves as a “wake-up command” for the A-IoT device.

3. DL Signal Reception: After waking up, the A-IoT device listens for the PSS, SSS, or other DL signals from the UE. These signals serve as an “inquiry command” for the A-IoT device.

4. Preamble Transmission: Upon receiving the DL signal, the A-IoT device generates a random 16-bit number (RN16) and sends it back to the UE. This is done through backscattering communication, using ASK or OOK modulation.

5. Acknowledgment Reception: The UE sends an acknowledgment signal back to the A-IoT device, which includes the RN16. Upon receiving this acknowledgment, the A-IoT device knows that the UE has successfully received its RN16.

6. RRC Connection Request: Once the A-IoT device receives the acknowledgment, it sends its Electronic Product Code (EPC) to the UE. This is done through backscattering communication, using ASK or OOK modulation.

7. Contention Resolution: The UE sends a contention resolution message to the A-IoT device, confirming the A-IoT device's EPC and completing the communication procedure.

By incorporating a passive wake-up mechanism, A-IoT devices can significantly enhance their energy efficiency, especially during idle or low-activity periods. This is particularly advantageous for A-IoT devices with different behaviors, as it allows for flexible power management strategies that can be tailored to the specific needs and characteristics of each device.

FIG. 12(B) is a sequence diagram 1220 for a passive wake-up mechanism. In this sequence diagram, the “A-IoT device” participant represents the A-IoT device, and the “UE” participant represents the User Equipment. The arrows represent the communication between the two participants, and the notes provide additional information about the behavior of each participant at each step of the procedure.

### Prioritized Backscattering

The implementation of prioritized backscattering, where Ambient Internet of Things (A-IoT) devices prioritize backscattering over other operations when their power level is low, can significantly enhance their energy efficiency and communication reliability. This solution, which necessitates complex power management algorithms, may increase the device's complexity but has the potential to prolong the device's operational lifespan and ensure reliable communication even under power constraints.

In a prioritized backscattering protocol, A-IoT devices not only communicate with a gNB or UE reader but also manage their power consumption based on the remaining power level. This can be facilitated through a modified communication process as follows:

1. Power Level Monitoring: The A-IoT device continuously monitors its remaining power level. When the power level is low, the device switches to a power-saving mode where it prioritizes backscattering over other operations.

2. DL Signal Reception: The A-IoT device listens for the PSS, SSS, or other DL signals from the gNB or UE reader. These signals serve as an “inquiry command” for the A-IoT device.

3. Preamble Transmission: Upon receiving the DL signal, the A-IoT device generates a random 16-bit number (RN16) and sends it back to the gNB or UE reader. This is done through prioritized backscattering communication, using ASK or OOK modulation.

4. Acknowledgment Reception: The gNB or UE reader sends an acknowledgment signal back to the A-IoT device, which includes the RN16. Upon receiving this acknowledgment, the A-IoT device knows that the gNB or UE reader has successfully received its RN16.

5. RRC Connection Request: Once the A-IoT device receives the acknowledgment, it sends its Electronic Product Code (EPC) to the gNB or UE reader. This is done through prioritized backscattering communication, using ASK or OOK modulation.

6. Contention Resolution: The gNB or UE reader sends a contention resolution message to the A-IoT device, confirming the A-IoT device's EPC and completing the communication procedure.

By incorporating prioritized backscattering, A-IoT devices can significantly enhance their energy efficiency and communication reliability, especially during low-power conditions. This is particularly advantageous for A-IoT devices with different behaviors, as it allows for flexible power management strategies that can be tailored to the specific needs and characteristics of each device.

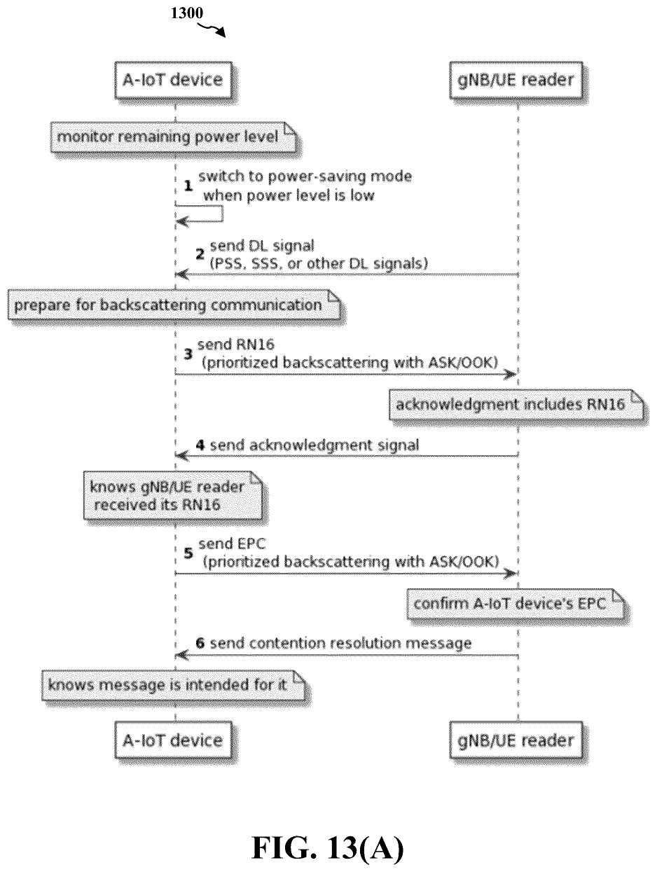

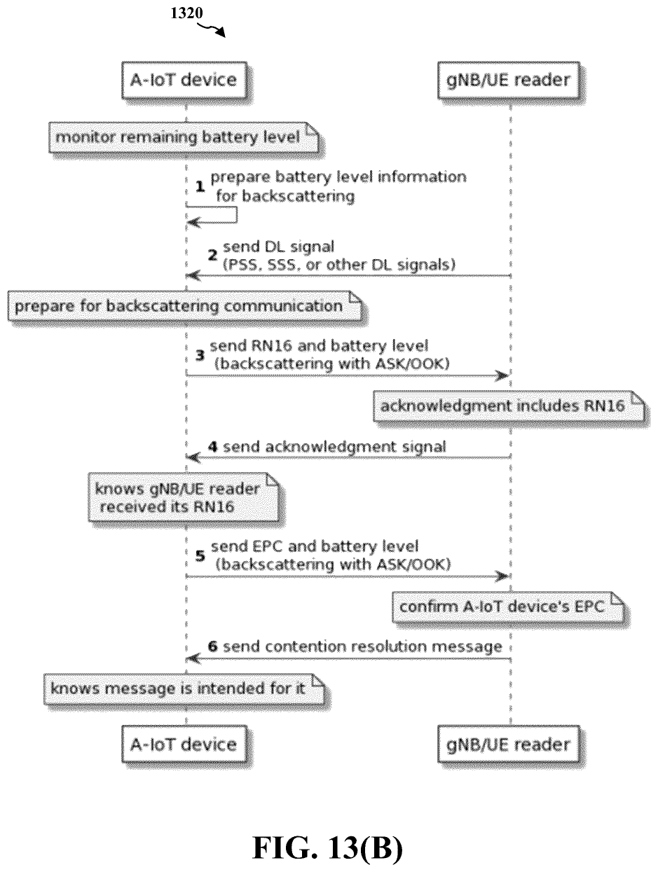

FIG. 13(A) is a sequence diagram 1300 for a prioritized backscattering mechanism. In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

### Battery Level Reporting

The implementation of battery level reporting, where Ambient Internet of Things (A-IoT) devices include battery level information in the backscattered signals, can significantly enhance their energy management and the overall network efficiency. This solution, which necessitates changes to the communication protocol, may increase the device's complexity but has the potential to provide valuable information for power management strategies and decision-making processes.

In a battery level reporting protocol, A-IoT devices not only communicate with a gNB or UE reader but also report their remaining battery level. This can be facilitated through a modified communication process as follows:

1. Battery Level Monitoring: The A-IoT device continuously monitors its remaining battery level. The battery level information is prepared to be included in the backscattered signals.

2. DL Signal Reception: The A-IoT device listens for the PSS, SSS, or other DL signals from the gNB or UE reader. These signals serve as an “inquiry command” for the A-IoT device.

3. Preamble Transmission with Battery Level Information: Upon receiving the DL signal, the A-IoT device generates a random 16-bit number (RN16) and sends it back to the gNB or UE reader. This is done through backscattering communication, using ASK or OOK modulation. Along with the RN16, the A-IoT device also includes the battery level information in the backscattered signals.

4. Acknowledgment Reception: The gNB or UE reader sends an acknowledgment signal back to the A-IoT device, which includes the RN16. Upon receiving this acknowledgment, the A-IoT device knows that the gNB or UE reader has successfully received its RN16.

5. RRC Connection Request with Battery Level Information: Once the A-IoT device receives the acknowledgment, it sends its Electronic Product Code (EPC) to the gNB or UE reader. This is done through backscattering communication, using ASK or OOK modulation. Along with the EPC, the A-IoT device also includes the battery level information in the backscattered signals.

6. Contention Resolution: The gNB or UE reader sends a contention resolution message to the A-IoT device, confirming the A-IoT device's EPC and completing the communication procedure.

By incorporating battery level reporting, A-IoT devices can significantly enhance their energy management and the overall network efficiency. This is particularly advantageous for A-IoT devices with different behaviors, as it allows for flexible power management strategies that can be tailored to the specific needs and characteristics of each device.

FIG. 13(B) is a sequence diagram 1320 for a battery level reporting mechanism. In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

### Charging Indication in gNB Signals

The gNB could include an indication in its signals when the A-IoT devices are being charged by the dedicated RF charging source.

The implementation of charging indication in gNB signals, where the gNB includes an indication in its signals when the Ambient Internet of Things (A-IoT) devices are being charged by the dedicated RF charging source, can significantly enhance energy management and the overall network efficiency. This solution, which necessitates changes to the communication protocol, may increase the complexity of the gNB but has the potential to provide valuable information for power management strategies and decision-making processes.

In a charging indication protocol, the gNB not only communicates with A-IoT devices but also indicates the charging status of the devices. This can be facilitated through a modified communication process as follows:

1. Charging Status Monitoring: The gNB continuously monitors the charging status of the A-IoT devices. When an A-IoT device is being charged by the dedicated RF charging source, the gNB prepares to include a charging indication in its signals.

2. DL Signal Transmission with Charging Indication: The gNB sends the PSS, SSS, or other DL signals to the A-IoT devices. These signals serve as an “inquiry command” for the A-IoT devices. Along with the DL signals, the gNB also includes the charging indication in its signals.

3. Charging Indication Reception and Preamble Transmission: Upon receiving the DL signal with the charging indication, the A-IoT device recognizes its charging status and prepares for further communication. The A-IoT device then generates a random 16-bit number (RN16) and sends it back to the gNB. This is done through backscattering communication, using ASK or OOK modulation.

4. Acknowledgment Transmission: The gNB sends an acknowledgment signal back to the A-IoT device, which includes the RN16. Upon receiving this acknowledgment, the A-IoT device knows that the gNB has successfully received its RN16.

5. RRC Connection Request: Once the A-IoT device receives the acknowledgment, it sends its Electronic Product Code (EPC) to the gNB. This is done through backscattering communication, using ASK or OOK modulation.

6. Contention Resolution: The gNB sends a contention resolution message to the A-IoT device, confirming the A-IoT device's EPC and completing the communication procedure.

By incorporating charging indication in gNB signals, the gNB can significantly enhance its energy management and the overall network efficiency. This is particularly advantageous for A-IoT networks with different device behaviors, as it allows for flexible power management strategies that can be tailored to the specific needs and characteristics of each device.

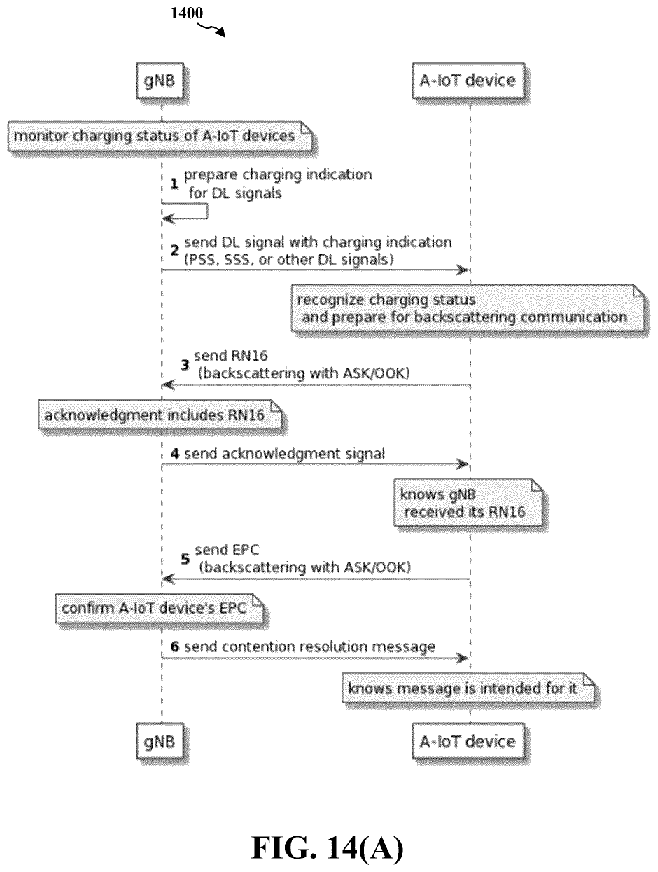

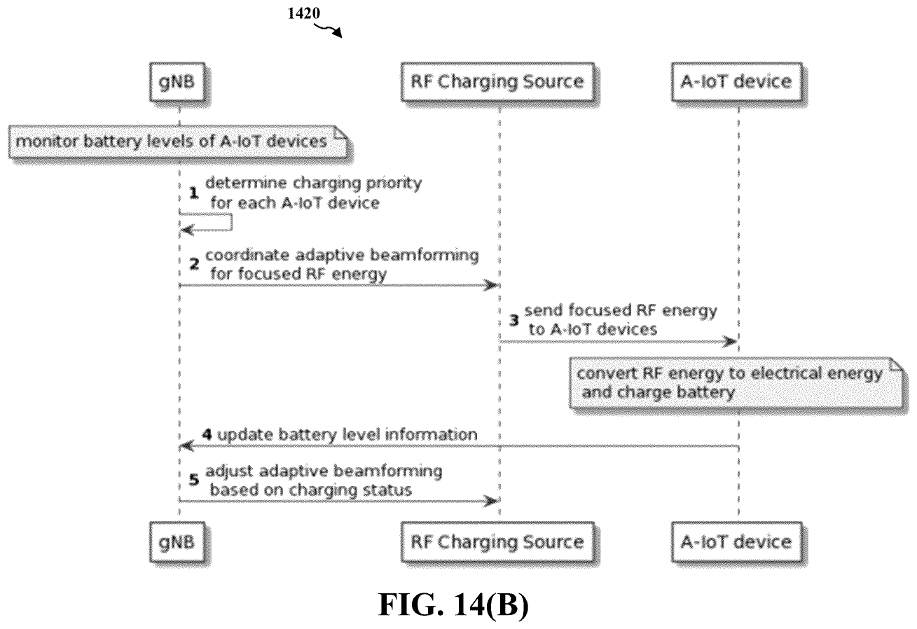

FIG. 14(A) is a sequence diagram 1400 for a charging indication mechanism. In this sequence diagram, the “gNB” participant represents the gNB, and the “A-IoT device” participant represents the A-IoT device. The arrows represent the communication between the two participants, and the notes provide additional information about the behavior of each participant at each step of the procedure.

### Adaptive Antenna Beamforming for Charging

The gNB and the dedicated RF charging source could cooperate to use adaptive antenna beamforming to focus the RF energy on the A-IoT devices that need charging the most.

### Adaptive Antenna Beamforming for Charging A-IoT Devices

The implementation of adaptive antenna beamforming for charging, where the gNB and the dedicated RF charging source cooperate to focus the RF energy on the Ambient Internet of Things (A-IoT) devices that need charging the most, can significantly enhance energy management and the overall network efficiency. This solution, which necessitates changes to the antenna design and operation of both the gNB and the charging source, may increase their complexity but has the potential to provide targeted and efficient charging for A-IoT devices.

In an adaptive antenna beamforming protocol, the gNB and the dedicated RF charging source work together to optimize the charging process for A-IoT devices. This can be facilitated through a modified charging process as follows:

1. Battery Level Monitoring: The gNB continuously monitors the battery levels of the A-IoT devices in the network.

2. Charging Priority Determination: Based on the battery level information, the gNB determines the charging priority for each A-IoT device. Devices with lower battery levels are given higher priority for charging.

3. Adaptive Beamforming Coordination: The gNB and the dedicated RF charging source cooperate to use adaptive antenna beamforming techniques to focus the RF energy on the A-IoT devices that need charging the most, according to the determined charging priorities.

4. Charging Process: The A-IoT devices receive the focused RF energy and convert it into electrical energy to charge their batteries.

5. Charging Status Update: The gNB and the dedicated RF charging source continuously update the charging status of the A-IoT devices and adjust the adaptive antenna beamforming accordingly.

By incorporating adaptive antenna beamforming for charging, the gNB and the dedicated RF charging source can significantly enhance energy management and the overall network efficiency. This is particularly advantageous for A-IoT networks with different device behaviors, as it allows for flexible power management strategies that can be tailored to the specific needs and characteristics of each device.

FIG. 14(B) is a sequence diagram 1420 for a adaptive antenna beamforming mechanism. In this sequence diagram, the “gNB” participant represents the gNB, the “RF Charging Source” participant represents the dedicated RF charging source, and the “A-IoT device” participant represents the A-IoT device. The arrows represent the communication and coordination between the participants

### Solar Energy Harvesting

The implementation of solar energy harvesting, where Ambient Internet of Things (A-IoT) devices are equipped with solar panels to harvest energy from indoor light, can significantly enhance their energy management and overall network efficiency. This solution, which necessitates the addition of solar panels to the A-IoT devices, can significantly extend the devices' battery life, especially in environments with sufficient lighting.

In a solar energy harvesting protocol, A-IoT devices not only communicate with a gNB or UE reader but also continuously harvest energy from indoor light. This can be facilitated through a modified operation process as follows:

1. Solar Panel Installation: Solar panels are installed on the A-IoT devices. These solar panels are capable of converting light energy into electrical energy, which can be used to power the devices.

2. Light Energy Harvesting: The A-IoT devices continuously harvest energy from indoor light through their solar panels. This harvested energy is stored in the devices' batteries for later use.

3. DL Signal Reception: The A-IoT device listens for the PSS, SSS, or other DL signals from the gNB or UE reader. These signals serve as an “inquiry command” for the A-IoT device.

4. Preamble Transmission: Upon receiving the DL signal, the A-IoT device generates a random 16-bit number (RN16) and sends it back to the gNB or UE reader. This is done through backscattering communication, using ASK or OOK modulation.

5. Acknowledgment Reception: The gNB or UE reader sends an acknowledgment signal back to the A-IoT device, which includes the RN16. Upon receiving this acknowledgment, the A-IoT device knows that the gNB or UE reader has successfully received its RN16.

6. RRC Connection Request: Once the A-IoT device receives the acknowledgment, it sends its Electronic Product Code (EPC) to the gNB or UE reader. This is done through backscattering communication, using ASK or OOK modulation.

7. Contention Resolution: The gNB or UE reader sends a contention resolution message to the A-IoT device, confirming the A-IoT device's EPC and completing the communication procedure.

By incorporating solar energy harvesting, A-IoT devices can significantly enhance their energy management and the overall network efficiency. This is particularly advantageous for A-IoT devices in environments with sufficient lighting, as it allows for flexible power management strategies that can be tailored to the specific needs and characteristics of each device.

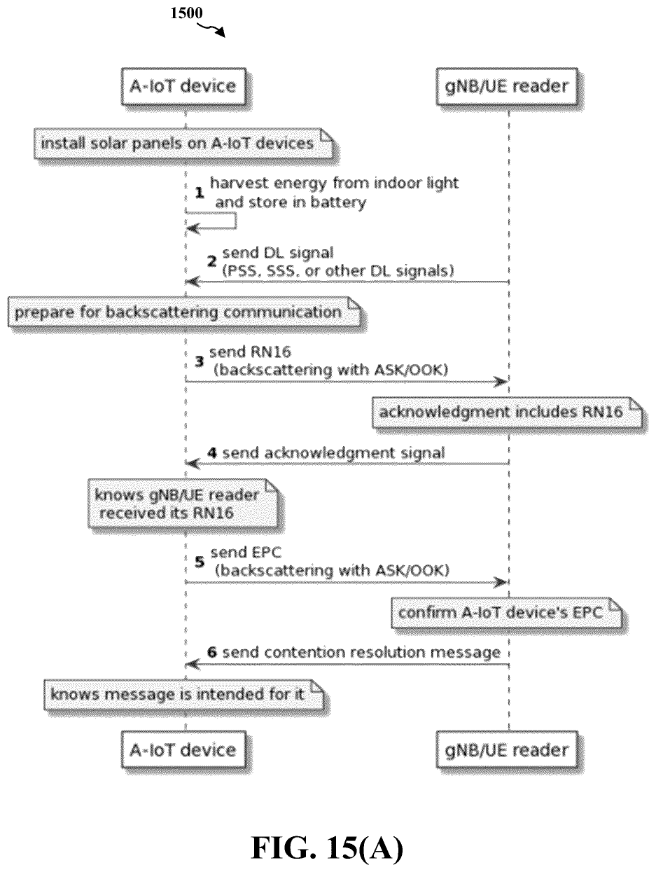

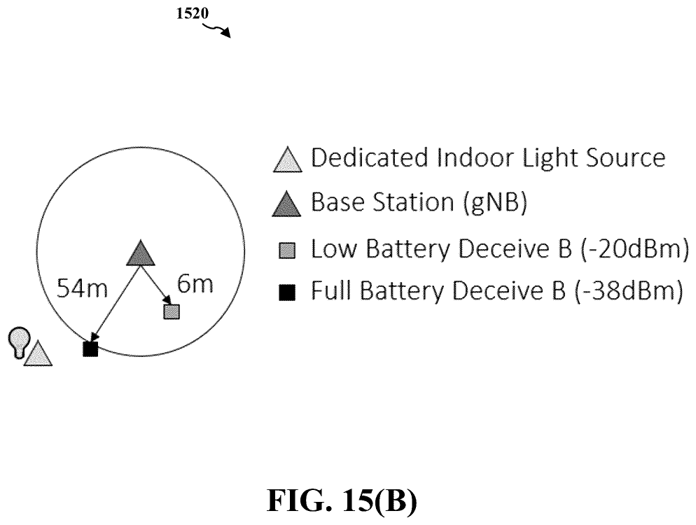

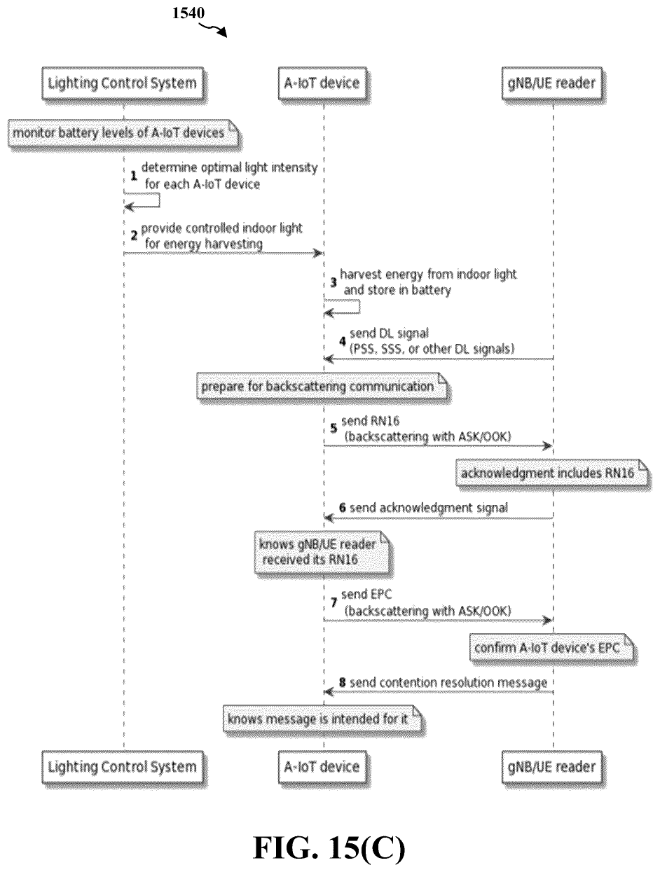

FIG. 15(A) is a sequence diagram 1500 for a solar energy harvesting mechanism. In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

### Adaptive Indoor Lighting Control

FIG. 15(B) is a diagram 1520 that describes implementation of a system to control the intensity of the indoor light based on the power needs of the A-IoT devices. For example, the light intensity could be increased when the devices' battery levels are low to provide more energy for solar harvesting.

The implementation of adaptive indoor lighting control, where a system controls the intensity of the indoor light based on the power needs of the Ambient Internet of Things (A-IoT) devices, can significantly enhance their energy management and overall network efficiency. This solution, which necessitates a controllable lighting system and intelligent control algorithms, is moderately feasible but has the potential to provide targeted and efficient energy supply for A-IoT devices, especially those equipped with solar panels for energy harvesting.

In an adaptive indoor lighting control protocol, the lighting control system not only provides lighting for the indoor environment but also adjusts the light intensity based on the power needs of the A-IoT devices. This can be facilitated through a modified operation process as follows:

1. Battery Level Monitoring: The lighting control system continuously monitors the battery levels of the A-IoT devices in the network.

2. Light Intensity Adjustment: Based on the battery level information, the lighting control system determines the optimal light intensity for each A-IoT device. For example, the light intensity could be increased when the devices' battery levels are low to provide more energy for solar harvesting.

3. Light Energy Harvesting: The A-IoT devices continuously harvest energy from the controlled indoor light through their solar panels. This harvested energy is stored in the devices' batteries for later use.

4. DL Signal Reception: The A-IoT device listens for the PSS, SSS, or other DL signals from the gNB or UE reader. These signals serve as an “inquiry command” for the A-IoT device.

5. Preamble Transmission: Upon receiving the DL signal, the A-IoT device generates a random 16-bit number (RN16) and sends it back to the gNB or UE reader. This is done through backscattering communication, using ASK or OOK modulation.

6. Acknowledgment Reception: The gNB or UE reader sends an acknowledgment signal back to the A-IoT device, which includes the RN16. Upon receiving this acknowledgment, the A-IoT device knows that the gNB or UE reader has successfully received its RN16.

7. RRC Connection Request: Once the A-IoT device receives the acknowledgment, it sends its Electronic Product Code (EPC) to the gNB or UE reader. This is done through backscattering communication, using ASK or OOK modulation.

8. Contention Resolution: The gNB or UE reader sends a contention resolution message to the A-IoT device, confirming the A-IoT device's EPC and completing the communication procedure.

By incorporating adaptive indoor lighting control, the lighting control system can significantly enhance energy management and the overall network efficiency. This is particularly advantageous for A-IoT devices in environments with controllable lighting systems, as it allows for flexible power management strategies that can be tailored to the specific needs and characteristics of each device.

FIG. 15(C) is a sequence diagram 1540 for an adaptive indoor lighting control mechanism. In this sequence diagram, the “Lighting Control System” participant represents the lighting control system, the “A-IoT device” participant represents the A-IoT device, and the “gNB/UE reader” participant represents the gNB or UE reader. The arrows represent the communication and coordination between the participants, and the notes provide additional information about the behavior of each participant at each step of the procedure.

### Lighting-Based Power Management

Implement a power management strategy that takes into account the availability of light for solar harvesting. For example, the A-IoT devices could perform more power-intensive operations when the indoor light is bright and switch to low-power mode when the light is dim. This solution is moderately feasible, as it would require light sensors on the devices and complex power management algorithms.

These solutions aim to ensure consistent device discoverability and reliable communication, regardless of the device's battery levels, by balancing power consumption and device functionality.

### Lighting-Based Power Management for A-IoT Devices

The implementation of lighting-based power management, where a power management strategy takes into account the availability of light for solar harvesting, can significantly enhance the energy management and overall network efficiency of Ambient Internet of Things (A-IoT) devices. This solution, which necessitates light sensors on the devices and complex power management algorithms, is moderately feasible but has the potential to provide flexible and efficient power management for A-IoT devices, especially those equipped with solar panels for energy harvesting.

In a lighting-based power management protocol, A-IoT devices not only communicate with a gNB or UE reader but also adjust their operations based on the availability of light for solar harvesting. This can be facilitated through a modified operation process as follows:

1. Light Sensor Installation and Monitoring: Light sensors are installed on the A-IoT devices. These sensors continuously monitor the availability of light in the environment.

2. Power Management Strategy Implementation: Based on the light availability information from the sensors, the A-IoT devices implement a power management strategy. For example, the devices could perform more power-intensive operations when the indoor light is bright and switch to a low-power mode when the light is dim.

3. DL Signal Reception: The A-IoT device listens for the PSS, SSS, or other DL signals from the gNB or UE reader. These signals serve as an “inquiry command” for the A-IoT device.

4. Preamble Transmission: Upon receiving the DL signal, the A-IoT device generates a random 16-bit number (RN16) and sends it back to the gNB or UE reader. This is done through backscattering communication, using ASK or OOK modulation.

5. Acknowledgment Reception: The gNB or UE reader sends an acknowledgment signal back to the A-IoT device, which includes the RN16. Upon receiving this acknowledgment, the A-IoT device knows that the gNB or UE reader has successfully received its RN16.

6. RRC Connection Request: Once the A-IoT device receives the acknowledgment, it sends its Electronic Product Code (EPC) to the gNB or UE reader. This is done through backscattering communication, using ASK or OOK modulation.

7. Contention Resolution: The gNB or UE reader sends a contention resolution message to the A-IoT device, confirming the A-IoT device's EPC and completing the communication procedure.

By incorporating lighting-based power management, A-IoT devices can significantly enhance their energy management and the overall network efficiency. This is particularly advantageous for A-IoT devices in environments with varying lighting conditions, as it allows for flexible power management strategies that can be tailored to the specific needs and characteristics of each device.

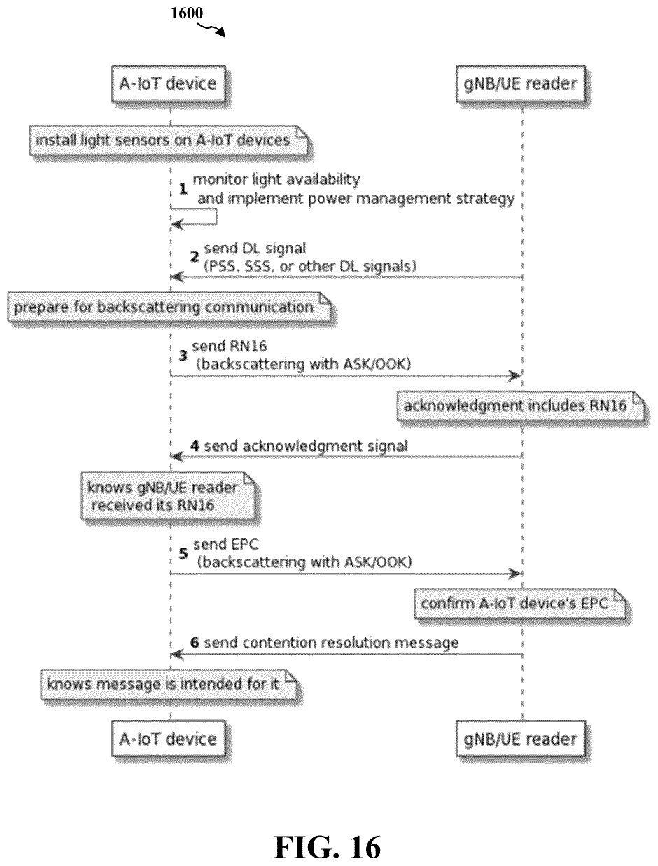

FIG. 16 is a sequence diagram 1600 for a lighting-based power management mechanism. In this sequence diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

These solutions aim to ensure consistent device discoverability and reliable communication, regardless of the device's battery levels, by balancing power consumption and device functionality.

In an aspect, a user equipment (UE), including:

one or more non-transitory computer-readable media having computer-executable instructions embodied thereon, and at least one processor coupled to the one or more non-transitory computer-readable media and configured to execute the computer-executable instructions to:

Receive from a base station (BS), a downlink signal (DL) that includes Primary Synchronization Signal (PSS), Secondary Synchronization Signal (SSS), or LP-WUS and a random 16-bit number (RN16), if the UE is an Ambient Internet of Things (A-IoT) device and is in a state to receive signals.

Determine the power level of the device based on the received DL signal and validate the received RN16, if the DL signal is successfully decoded and the RN16 is valid.

Perform a power management strategy based on the determined power level and send the RN16 along with the Electronic Product Code (EPC) to the BS using backscattering communication with Amplitude Shift Keying (ASK) or On-Off Keying (OOK), if the power level is determined and the RN16 is validated.

Transmit, to the BS, an acknowledgment message upon receiving a final acknowledgment message from the BS, if the final acknowledgment message includes the RN16 and the EPC.

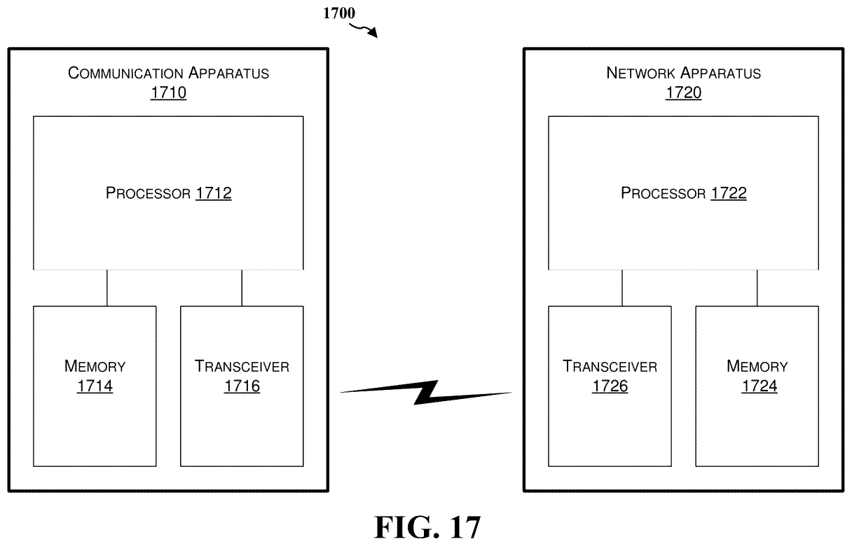

FIG. 17 illustrates an example communication system 1700 having an example communication apparatus 1710 and an example network apparatus 1720 in accordance with an implementation of the present disclosure. Each of communication apparatus 1710 and network apparatus 1720 may perform various functions to implement schemes, techniques, processes and methods described herein pertaining to using on-demand reference signal for network energy saving with respect to user equipment and network apparatus in mobile communications, including scenarios/schemes described above as well as processes 1800 and 1900 described below.

Communication apparatus 1710 may be a part of an electronic apparatus, which may be a UE such as a portable or mobile apparatus, a wearable apparatus, a wireless communication apparatus or a computing apparatus. For instance, communication apparatus 1710 may be implemented in a smartphone, a smartwatch, a personal digital assistant, a digital camera, or a computing equipment such as a tablet computer, a laptop computer or a notebook computer. Communication apparatus 1710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1710 may be implemented in a smart thermostat, a smart fridge, a smart door lock, a wireless speaker or a home control center. Alternatively, communication apparatus 1710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1710 may include at least some of those components shown in FIG. 17 such as a processor 1712, for example. Communication apparatus 1710 may further include one or more other components not pertinent to the proposed scheme of the present disclosure (e.g., internal power supply, display device and/or user interface device), and, thus, such component(s) of communication apparatus 1710 are neither shown in FIG. 17 nor described below in the interest of simplicity and brevity.

Network apparatus 1720 may be a part of a network apparatus, which may be a network node such as a satellite, a base station, a small cell, a router or a gateway. For instance, network apparatus 1720 may be implemented in an eNodeB in an LTE network, in a gNB in a 5G/NR, IoT, NB-IoT or IIoT network or in a satellite or base station in a 6G network. Alternatively, network apparatus 1720 may be implemented in the form of one or more IC chips such as, for example and without limitation, one or more single-core processors, one or more multi-core processors, or one or more RISC or CISC processors. Network apparatus 1720 may include at least some of those components shown in FIG. 17 such as a processor 1722, for example. Network apparatus 1720 may further include one or more other components not pertinent to the proposed scheme of the present disclosure (e.g., internal power supply, display device and/or user interface device), and, thus, such component(s) of network apparatus 1720 are neither shown in FIG. 17 nor described below in the interest of simplicity and brevity.

In one aspect, each of processor 1712 and processor 1722 may be implemented in the form of one or more single-core processors, one or more multi-core processors, or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including autonomous reliability enhancements in a device (e.g., as represented by communication apparatus 1710) and a network (e.g., as represented by network apparatus 1720) in accordance with various implementations of the present disclosure.

In some implementations, communication apparatus 1710 may also include a transceiver 1716 coupled to processor 1712 and capable of wirelessly transmitting and receiving data. In some implementations, communication apparatus 1710 may further include a memory 1714 coupled to processor 1712 and capable of being accessed by processor 1712 and storing data therein. In some implementations, network apparatus 1720 may also include a transceiver 1726 coupled to processor 1722 and capable of wirelessly transmitting and receiving data. In some implementations, network apparatus 1720 may further include a memory 1724 coupled to processor 1722 and capable of being accessed by processor 1722 and storing data therein. Accordingly, communication apparatus 1710 and network apparatus 1720 may wirelessly communicate with each other via transceiver 1716 and transceiver 1726, respectively. To aid better understanding, the following description of the operations, functionalities and capabilities of each of communication apparatus 1710 and network apparatus 1720 is provided in the context of a mobile communication environment in which communication apparatus 1710 is implemented in or as a communication apparatus or a UE and network apparatus 1720 is implemented in or as a network node of a communication network.

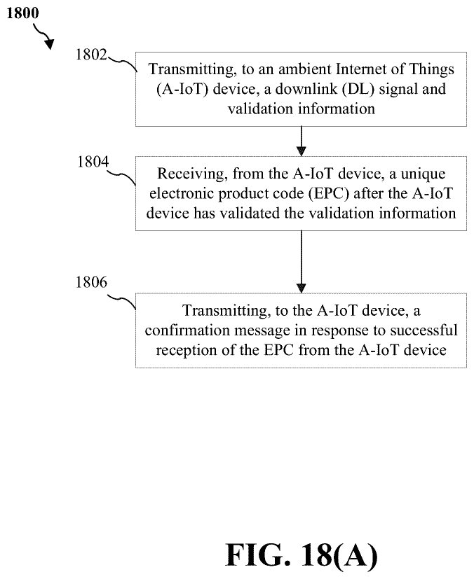

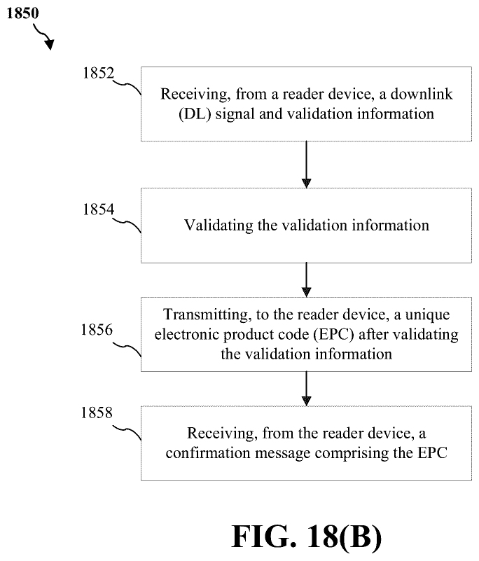

FIG. 18(A) is a flow chart 1800 of a process for handling the uncertainty on battery level regarding a reader device and an A-IoT device. This process involves interactions between a gNB, a UE (e.g., the UE 744), and an ambient Internet of Things (A-IoT) device (e.g., the A-IoT device 746).

At block 1802, a reader device may transmit, to an ambient Internet of Things (A-IoT) device such as the A-IoT device 746, a downlink (DL) signal and validation information. The reader device may be the UE 744 or the gNB.

Then, at block 1804, the reader device, e.g., the UE 744, may receive from the A-IoT device 746, a unique electronic product code (EPC) after the A-IoT device 746 has validated the validation information.

Finally, at block 1806, the reader device may transmit, to the A-IoT device 746, a confirmation message in response to successful reception of the EPC from the A-IoT device 746.

In some embodiments, the DL signal may include at least one of a primary synchronization signal (PSS), a secondary synchronization signal (SSS), or a low power wake-up signal (LP-WUS), and wherein the validation information comprises a random 16-bit number (RN16).

In some embodiments, the process may further include: receiving, from the A-IoT device 746, a power level indication. In some embodiments, the power level indication and the EPC may be received in a single response from the A-IoT device 746 or in separate responses from the A-IoT device 746.

In some embodiments, the power level indication may include at least one of: a signal strength indicator indicating a strength of a signal received by the A-IoT device; a quality indicator indicating a quality of the signal; a binary indicator indicating whether a power level of the A-IoT device is above or below a threshold; or a battery level indicator indicating a remaining battery life of the A-IoT device.

In some embodiments, the DL signal may include instructions for measuring and reporting a power level of the A-IoT device 746.

In some embodiments, the process may further include: configuring at least one of a transmission power, a modulation and coding scheme, or a scheduling decision based on the received power level indication. In some embodiments, the power level indication may include a low power mode indication.

In some embodiments, the validation information may be transmitted along with the DL signal.

In some embodiments, the process may further include: receiving the validation information from the A-IoT device 746; and transmitting an acknowledgement message including the validation information to the A-IoT device 746.

FIG. 18(B) is a flow chart 1850 of another process for handling the uncertainty on battery level regarding a reader device and an A-IoT device.

At block 1852, an A-IoT device, e.g., the A-IoT device 746, may receive, from a reader device, a downlink (DL) signal and validation information. The reader device, may be a UE, e.g., the UE 744, or a gNB.

Then, at block 1854, the A-IoT device 746 may validate the validation information.

Subsequently, at block 1856, the A-IoT device 746 may transmit, to the reader device, a unique electronic product code (EPC) after validating the validation information.

Finally, at block 1858, the A-IoT device 746 may receive, from the reader device, a confirmation message including the EPC.

In some embodiments, the DL signal may include at least one of a primary synchronization signal (PSS), a secondary synchronization signal (SSS), or a low power wake-up signal (LP-WUS), and the validation information may include a random 16-bit number (RN16).

In some embodiments, the process may include: transmitting, to the reader device, a power level indication. In some embodiments, the power level indication and the EPC may be transmitted in a single response to the reader device or in separate responses to the reader device.

In some embodiments, the power level indication may include at least one of: a signal strength indicator indicating a strength of a signal received by the A-IoT device 746; a quality indicator indicating a quality of the signal; a binary indicator indicating whether a power level of the A-IoT device 746 is above or below a threshold; or a battery level indicator indicating a remaining battery life of the A-IoT device 746.

In some embodiments, the process may include: measuring a power level of the A-IoT device 746; and reporting the power level based on instructions received in the DL signal.

In some embodiments, the process may include: measuring a current power level of the A-IoT device 746; switching to a low power mode when the current power level falls below a threshold; and including a low power mode indication in the power level indication.

In some embodiments, transmitting the validation information, the power level indication, and the EPC to the reader device may include using backscattering communication with amplitude shift keying (ASK) or on-off keying (OOK) modulation.

In some embodiments, the process may include: harvesting energy through a lighting energy collector; and storing the harvested energy in a battery of the A-IoT device 746. In some embodiments, the energy harvesting is controlled by a lighting control system that: monitors a battery level of the A-IoT device 746; and determines an optimal light intensity for the A-IoT device 746 based on the monitored battery level.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a reader device, comprising:
transmitting, to an ambient Internet of Things (A-IoT) device, a downlink (DL) signal and validation information;
receiving, from the A-IoT device, a unique electronic product code (EPC) after the A-IoT device has validated the validation information; and
transmitting, to the A-IoT device, a confirmation message in response to successful reception of the EPC from the A-IoT device.

2. The method of claim 1, wherein the DL signal comprises at least one of a primary synchronization signal (PSS), a secondary synchronization signal (SSS), or a low power wake-up signal (LP-WUS), and wherein the validation information comprises a random 16-bit number (RN16).

3. The method of claim 1, further comprising:
receiving, from the A-IoT device, a power level indication.

4. The method of claim 3, wherein the power level indication and the EPC are received in a single response from the A-IoT device or in separate responses from the A-IoT device.

5. The method of claim 3, wherein the power level indication comprises at least one of:
a signal strength indicator indicating a strength of a signal received by the A-IoT device;
a quality indicator indicating a quality of the signal;
a binary indicator indicating whether a power level of the A-IoT device is above or below a threshold; or
a battery level indicator indicating a remaining battery life of the A-IoT device.

6. The method of claim 3, wherein the DL signal comprises instructions for measuring and reporting a power level of the A-IoT device.

7. The method of claim 3, further comprising:
configuring at least one of a transmission power, a modulation and coding scheme, or a scheduling decision based on the received power level indication.

8. The method of claim 3, wherein the power level indication comprises a low power mode indication.

9. The method of claim 1, wherein the validation information is transmitted along with the DL signal.

10. The method of claim 1, further comprising:
receiving the validation information from the A-IoT device; and
transmitting an acknowledgement message including the validation information to the A-IoT device.

11. A method of wireless communication of an ambient Internet of Things (A-IoT) device, comprising:
receiving, from a reader device, a downlink (DL) signal and validation information;
validating the validation information;
transmitting, to the reader device, a unique electronic product code (EPC) after validating the validation information; and
receiving, from the reader device, a confirmation message comprising the EPC.

12. The method of claim 11, wherein the DL signal comprises at least one of a primary synchronization signal (PSS), a secondary synchronization signal (SSS), or a low power wake-up signal (LP-WUS), and wherein the validation information comprises a random 16-bit number (RN16).

13. The method of claim 11, further comprising:
transmitting, to the reader device, a power level indication.

14. The method of claim 13, wherein the power level indication and the EPC are transmitted in a single response to the reader device or in separate responses to the reader device.

15. The method of claim 13, wherein the power level indication comprises at least one of:
a signal strength indicator indicating a strength of a signal received by the A-IoT device;
a quality indicator indicating a quality of the signal;
a binary indicator indicating whether a power level of the A-IoT device is above or below a threshold; or
a battery level indicator indicating a remaining battery life of the A-IoT device.

16. The method of claim 13, further comprising:
measuring a power level of the A-IoT device; and
reporting the power level based on instructions received in the DL signal.

17. The method of claim 13, further comprising:
measuring a current power level of the A-IoT device;
switching to a low power mode when the current power level falls below a threshold; and
including a low power mode indication in the power level indication.

18. The method of claim 13, wherein transmitting the validation information, the power level indication, and the EPC to the reader device comprises using backscattering communication with amplitude shift keying (ASK) or on-off keying (OOK) modulation.

19. The method of claim 11, further comprising:
harvesting energy through a lighting energy collector; and
storing the harvested energy in a battery of the A-IoT device,
wherein the energy harvesting is controlled by a lighting control system that:
monitors a battery level of the A-IoT device; and
determines an optimal light intensity for the A-IoT device based on the monitored battery level.

20. An apparatus for wireless communication, the apparatus being a reader device, comprising:
a memory; and
at least one processor coupled to the memory and configured to:
transmit, to an ambient Internet of Things (A-IoT) device, a downlink (DL) signal and validation information;
receive, from the A-IoT device, a unique electronic product code (EPC) after the A-IoT device has validated the validation information; and
transmit, to the A-IoT device, a confirmation message in response to successful reception of the EPC from the A-IoT device.
